(19) United States
(12) Patent Application Publication
(10) Pub. No.: US 2023/0368801 A1
(43) Pub. Date: Nov. 16, 2023

(54) BIT ALLOCATION METHOD AND APPARATUS FOR AUDIO OBJECT

(71) Applicant: HUAWEI TECHNOLOGIES CO., LTD., SHENZHEN (CN)

(72) Inventors: Xianbo MENG, Beijing (CN); Bin WANG, Shenzhen (CN); Zhe WANG, Beijing (CN); Bingyin XIA, Beijing (CN)

(21) Appl. No.: 18/224,237

(22) Filed: Jul. 20, 2023

Related U.S. Application Data
(63) Continuation of application No. PCT/CN2022/071148, filed on Jan. 10, 2022.

(30) Foreign Application Priority Data
Jan. 21, 2021 (CN) 202110083715.8

(51) Int. Cl. G10L 19/002; G10L 19/02; G10L 25/21

(52) U.S. Cl. CPC G10L 19/002; G10L 19/02; G10L 25/21

(57) ABSTRACT

A bit allocation method and apparatus for an audio object are disclosed, which relate to the field of audio encoding and decoding technologies. The method includes: separately pre-rendering a plurality of audio objects to be pre-rendered in an audio frame, to obtain a plurality of pre-rendered audio objects; obtaining respective perceptual importance parameter values of the plurality of pre-rendered audio objects; obtaining a bit allocation parameter value of a current audio object to be pre-rendered based on the respective perceptual importance parameter values of the plurality of pre-rendered audio objects; and determining, based on the bit allocation parameter value of the current audio object to be pre-rendered and a total quantity of to-be-allocated bits corresponding to the plurality of audio objects to be pre-rendered, a target quantity of bits allocated to the current audio object to be pre-rendered.

### CROSS-REFERENCE TO RELATED APPLICATIONS

This application is a continuation of International Application No. PCT/CN2022/071148, filed on Jan. 10, 2022, which claims priority to Chinese Patent Application No. 202110083715.8, filed on Jan. 21, 2021. The disclosures of the aforementioned applications are hereby incorporated by reference in their entireties.

### TECHNICAL FIELD

This application relates to the field of audio encoding and decoding technologies, and in particular, to a bit allocation method and apparatus for an audio object.

### BACKGROUND

A three-dimensional audio (3D audio) technology endows sound with a strong sense of space, encirclement, and immersion, to provide people with an extraordinary auditory experience “as if they are really there”. In recent years, people pay more attention to development of audio technologies.

An object-based audio technology is an important manner of implementing three-dimensional audio. A relatively independent audio object may be represented as an audio scene with a sense of space and more vivid auditory experience by using a rendering technology. A quantity of bits used by an encoder side to encode an audio object is an important factor that affects quality of an audio object reconstructed by a decoder side. Therefore, at a fixed bit rate, how to allocate a quantity of bits between audio objects to endow a rendered three-dimensional audio scene with high quality is one of important directions of current audio encoding research.

Currently, a common bit allocation method for an audio object is as follows: A total quantity of bits is evenly allocated to a plurality of audio objects in an audio frame. This causes low overall quality and low encoding efficiency of a reconstructed audio object.

### SUMMARY

Embodiments of this application provide a bit allocation method and apparatus for an audio object, to help improve overall quality and encoding efficiency of a reconstructed audio object.

To achieve the foregoing objective, this application provides the following technical solutions.

According to a first aspect, a bit allocation method for an audio object is provided, including: separately pre-rendering a plurality of audio objects to be pre-rendered in a to-be-encoded audio frame, to obtain a plurality of pre-rendered audio objects; obtaining respective perceptual importance parameter values of the plurality of pre-rendered audio objects, where a perceptual importance parameter value of a current pre-rendered audio object in the plurality of pre-rendered audio objects indicates a perceptual importance degree of the current pre-rendered audio object in the plurality of pre-rendered audio objects, and the current pre-rendered audio object may be any one of the plurality of pre-rendered audio objects; then, obtaining a bit allocation parameter value of a current audio object to be pre-rendered in the plurality of audio objects to be pre-rendered based on the respective perceptual importance parameter values of the plurality of pre-rendered audio objects, where the current audio object to be pre-rendered may be any one of the plurality of audio objects to be pre-rendered; and finally, determining, based on the bit allocation parameter value of the current audio object to be pre-rendered and a total quantity of to-be-allocated bits corresponding to the plurality of audio objects to be pre-rendered, a target quantity of bits allocated to the current audio object to be pre-rendered. For example, the total quantity of to-be-allocated bits may be used to encode the plurality of audio objects to be pre-rendered. The target quantity of bits may be used to encode the current audio object to be pre-rendered.

In this technical solution, when a quantity of bits is allocated to an audio object to be pre-rendered, a difference between perceptual characteristics of different pre-rendered audio objects at a rendering playback end is considered. Compared with a technical solution in a conventional technology in which different audio objects are encoded by using a same quantity of bits, this helps improve overall quality of a reconstructed audio object. For example, a higher perceptual importance degree indicated by a perceptual importance parameter value of a pre-rendered audio object indicates a larger quantity of bits that an encoder may allocate to an audio object to be pre-rendered (namely, an audio object of the pre-rendered audio object before pre-rendering) corresponding to the pre-rendered audio object, and the quantity of bits may be used to encode the audio object to be pre-rendered. In this case, quality of an audio object reconstructed by a decoder is higher. This helps improve overall quality of a reconstructed audio frame including a plurality of audio objects. In addition, this can improve encoding efficiency.

In one embodiment, the perceptual importance degree includes at least one of an energy intensity degree and a spectrum change degree.

In one embodiment, a perceptual importance parameter includes an energy importance parameter. An energy importance parameter of the current pre-rendered audio object is obtained through calculation based on energy of the current pre-rendered audio object, and indicates a ratio of the energy of the current pre-rendered audio object to a sum of respective energy of the plurality of pre-rendered audio objects.

In one embodiment, the perceptual importance parameter includes a perceptual intensity importance parameter. A perceptual intensity importance parameter of the current pre-rendered audio object is obtained through calculation based on an auditory curve of a human ear and energy of the current pre-rendered audio object, and indicates a ratio of a sum of energy of a preset quantity of frequency bands that have maximum energy and that are in a plurality of frequency bands of the current pre-rendered audio object to a sum of energy of a preset quantity of frequency bands that have maximum energy and that are in respective plurality of frequency bands of the plurality of pre-rendered audio objects.

In one embodiment, the perceptual importance parameter includes a spectral flatness parameter. A spectral flatness parameter of the current pre-rendered audio object indicates spectral flatness of the current pre-rendered audio object in the plurality of pre-rendered audio objects.

In one embodiment, the current pre-rendered audio object is an audio object obtained by pre-rendering the current audio object to be pre-rendered. The bit allocation parameter value of the current audio object to be pre-rendered includes a first ratio, or a parameter value determined based on a first ratio. The first ratio is a ratio of the perceptual importance parameter value of the current pre-rendered audio object to a sum of the respective perceptual importance parameter values of the plurality of pre-rendered audio objects. The possible design provides a specific implementation of obtaining the bit allocation parameter value of the current audio object to be pre-rendered. This manner is easy to implement.

In one embodiment, the method further includes obtaining respective content importance parameter values of the plurality of audio objects to be pre-rendered. A content importance parameter value of the current audio object to be pre-rendered indicates an importance degree of a sound type represented by content of the current audio object to be pre-rendered in sound types represented by content of the plurality of audio objects to be pre-rendered. In this case, the obtaining a bit allocation parameter value of a current audio object to be pre-rendered in the plurality of audio objects to be pre-rendered based on the respective perceptual importance parameter values of the plurality of pre-rendered audio objects includes: obtaining the bit allocation parameter value of the current audio object to be pre-rendered based on the respective perceptual importance parameter values of the plurality of pre-rendered audio objects and the respective content importance parameter values of the plurality of audio objects to be pre-rendered. In the embodiment, when a quantity of bits is allocated to an audio object to be pre-rendered, a difference between content features of different audio objects to be pre-rendered is further considered. Therefore, compared with a technical solution in a conventional technology in which different audio objects are encoded by using a same quantity of bits, this can further improve overall quality and encoding efficiency of a reconstructed audio object.

In one embodiment, the current pre-rendered audio object is an audio object obtained by pre-rendering the current audio object to be pre-rendered. The bit allocation parameter value of the current audio object to be pre-rendered includes a second ratio, or a parameter value determined based on a second ratio. The second ratio is a ratio of a first value of the current audio object to be pre-rendered to a sum of respective first values of the plurality of audio objects to be pre-rendered. The first value of the current audio object to be pre-rendered is a product of the content importance parameter value of the current audio object to be pre-rendered and the perceptual importance parameter value of the current pre-rendered audio object, or a parameter value determined based on “a product of the content importance parameter value of the current audio object to be pre-rendered and the perceptual importance parameter value of the current pre-rendered audio object”. The possible design provides another specific implementation of obtaining the bit allocation parameter value of the current audio object to be pre-rendered. This manner is easy to implement.

In one embodiment, the sound type includes at least one of the following: voice, music, sound effect, ambient sound, or noise.

In one embodiment, a ratio of the target quantity of bits allocated to the current audio object to be pre-rendered to the total quantity of to-be-allocated bits is equal to a third ratio, or is equal to a parameter value determined based on a third ratio. The third ratio is a ratio of the bit allocation parameter value of the current audio object to be pre-rendered to a sum of respective bit allocation parameter values of the plurality of audio objects to be pre-rendered. The possible design provides a specific implementation of determining the target quantity of bits allocated to the current audio object to be pre-rendered. In the embodiment, audio objects to be pre-rendered with different bit allocation parameter values may correspond to different target quantities of bits.

In one embodiment, the determining, based on the bit allocation parameter value of the current audio object to be pre-rendered and a total quantity of to-be-allocated bits, a target quantity of bits allocated to the current audio object to be pre-rendered includes: determining a priority level of the current audio object to be pre-rendered based on the bit allocation parameter value of the current audio object to be pre-rendered and a correspondence between a plurality of bit allocation parameter values and a plurality of priority levels; and then, determining, based on the priority level of the current audio object to be pre-rendered and the total quantity of to-be-allocated bits, the target quantity of bits allocated to the current audio object to be pre-rendered. The possible design provides another specific implementation of determining the target quantity of bits allocated to the current audio object to be pre-rendered. In the embodiment, audio objects to be pre-rendered with different bit allocation parameter values may correspond to a same target quantity of bits or different target quantities of bits.

In one embodiment, a ratio of the target quantity of bits allocated to the current audio object to be pre-rendered to the total quantity of to-be-allocated bits is equal to a fourth ratio, or is equal to a parameter value determined based on a fourth ratio. The fourth ratio is a ratio of the priority level of the current audio object to be pre-rendered to a sum of respective priority levels of the plurality of audio objects to be pre-rendered.

In one embodiment, the based on the bit allocation parameter value of the current audio object to be pre-rendered and a total quantity of to-be-allocated bits corresponding to the plurality of audio objects to be pre-rendered includes: obtaining an initial quantity of bits allocated to the current audio object to be pre-rendered; adjusting the bit allocation parameter value of the current audio object to be pre-rendered based on the initial quantity of bits; and determining, based on the total quantity of to-be-allocated bits and an adjusted bit allocation parameter value of the current audio object to be pre-rendered, the target quantity of bits allocated to the current audio object to be pre-rendered. The possible design provides another implementation of determining the target quantity of bits allocated to the current audio object to be pre-rendered.

In the embodiment, the bit allocation parameter value of the current audio object to be pre-rendered is adjusted by using the initial quantity of bits allocated to the current audio object to be pre-rendered. This helps further improve overall quality and encoding efficiency of a reconstructed audio object. In addition, the initial quantity of bits may be obtained based on a conventional technology. In other words, the possible design provides a solution in which the conventional technology is combined with the technology provided in this embodiment of this application. Alternatively, the initial quantity of bits may be obtained based on one of the technical solutions provided in this embodiment of this application. In other words, the possible design provides a solution combining a plurality of technologies provided in this embodiment of this application.

In one embodiment, the adjusted bit allocation parameter value of the current audio object to be pre-rendered includes a fifth ratio or a parameter value determined based on a fifth ratio. The fifth ratio is a ratio of a second value of the current audio object to be pre-rendered to a sum of respective second values of the plurality of audio objects to be pre-rendered. The second value of the current audio object to be pre-rendered is a product of the initial quantity of bits allocated to the current audio object to be pre-rendered and the bit allocation parameter value of the current audio object to be pre-rendered, or a parameter value determined based on “a product of the initial quantity of bits allocated to the current audio object to be pre-rendered and the bit allocation parameter value of the current audio object to be pre-rendered”. The possible design provides a specific implementation of adjusting the bit allocation parameter value.

In one embodiment, the ratio of the target quantity of bits allocated to the current audio object to be pre-rendered to the total quantity of to-be-allocated bits is equal to the adjusted bit allocation parameter value of the current audio object to be pre-rendered, or is equal to a parameter value determined based on the adjusted bit allocation parameter value of the current audio object to be pre-rendered. The possible design provides a specific implementation of determining the target quantity of bits allocated to the current audio object to be pre-rendered.

In one embodiment, the method further includes: sending proportion information of target quantities of bits respectively allocated to the plurality of audio objects to be pre-rendered. The proportion information is used to reconstruct the plurality of audio objects to be pre-rendered.

According to a second aspect, a bit allocation apparatus for an audio object is provided. The bit allocation apparatus for an audio object may be an encoder or an encoding device including an encoder. For example, the encoder may be a stereo encoder, a multi-channel encoder, or the like. For example, the encoding device may be a terminal, for example, a mobile terminal or a fixed network terminal. Alternatively, the encoding device may be a network device, for example, a media gateway, a transcoding device, or a media resource server in a radio access network or a core network.

In one embodiment, the bit allocation apparatus for an audio object is configured to perform any method provided in the first aspect. In this application, the bit allocation apparatus for an audio object may be divided into function modules according to the methods provided in the first aspect. For example, each function module may be obtained through division based on each corresponding function, or two or more functions may be integrated into one processing module. For example, in this application, the bit allocation apparatus for an audio object may be divided into a pre-rendering module, an obtaining module, a determining module, and the like based on functions. For descriptions of possible technical solutions performed by the foregoing function modules obtained through division and beneficial effects, refer to the corresponding technical solutions in the first aspect. Details are not described herein again.

In another possible design, the bit allocation apparatus for an audio object includes a processor, configured to implement any method described in the first aspect. The apparatus may further include a memory. The memory is coupled to the processor. When executing instructions stored in the memory, the processor can implement any method described in the first aspect. The device may further include a communication interface, and the communication interface is used by the device to communicate with another device. For example, the communication interface may be a transceiver, a circuit, a bus, a module, or another type of communication interface. In this application, the instructions in the memory may be pre-stored, or may be downloaded from the internet when the apparatus is used and then stored. A source of the instructions in the memory is not uniquely limited in this application. Coupling in this embodiment of this application is indirect coupling or connection between units or modules, may be in an electrical form, a mechanical form, or another form, and is used for information exchange between the units or the modules.

According to a third aspect, a computer-readable storage medium is provided, for example, a non-transient computer-readable storage medium. A computer program (or instructions) is stored on in the storage medium. When the computer program (or instructions) is run on a computer, the computer is enabled to perform any method provided in the first aspect.

According to a fourth aspect, a computer program product is provided. When the computer program product runs on a computer, any method provided in the first aspect is performed.

According to a fifth aspect, an audio system is provided, including an encoding apparatus and a decoding apparatus. The encoding apparatus is configured to perform any method provided in the first aspect. The decoding apparatus is configured to receive information sent by the encoding apparatus, and perform a decoding process. For example, the encoding apparatus may be an encoder (for example, a stereo encoder or a multi-channel encoder) or an encoding device (for example, a terminal or a network device) including an encoder. Correspondingly, the decoding apparatus may be a decoder (for example, a stereo decoder or a multi-channel decoder) or a decoding device (for example, a terminal or a network device) including a decoder.

It may be understood that any one of the bit allocation apparatus for an audio object, the computer storage medium, the computer program product, or the audio system provided above may be applied to the corresponding method provided above. Therefore, for beneficial effects that can be achieved by the bit allocation apparatus for an audio object, the computer storage medium, the computer program product, or the audio system, refer to the beneficial effects in the corresponding method. Details are not described herein again.

In this application, a name of the bit allocation apparatus for an audio object constitutes no limitation on devices or function modules. During actual implementation, these devices or function modules may have other names. Each device or function module falls within the scope defined by the claims and their equivalent technologies in this application, provided that a function of the device or function module is similar to that described in this application.

These aspects or other aspects in this application are more concise and comprehensible in the following descriptions.

### BRIEF DESCRIPTION OF DRAWINGS

FIG. 1A is a schematic diagram 1 of a structure of an audio system to which a technical solution according to an embodiment of this application is applicable;

FIG. 1B is a schematic diagram 2 of a structure of an audio system to which a technical solution according to an embodiment of this application is applicable;

FIG. 2 is a schematic diagram 3 of a structure of an audio system to which a technical solution according to an embodiment of this application is applicable;

FIG. 3A is a schematic diagram 4 of a structure of an audio system to which a technical solution according to an embodiment of this application is applicable;

FIG. 3B is a schematic diagram 5 of a structure of an audio system to which a technical solution according to an embodiment of this application is applicable;

FIG. 4 is a schematic diagram 6 of a structure of an audio system to which a technical solution according to an embodiment of this application is applicable;

FIG. 5 is a schematic diagram of a hardware structure of a computer device according to an embodiment of this application;

FIG. 6 is a schematic flowchart 1 of a bit allocation method for an audio object according to an embodiment of this application;

FIG. 7 is a schematic flowchart of determining a target quantity of bits according to an embodiment of this application;

FIG. 8 is a schematic flowchart 2 of a bit allocation method for an audio object according to an embodiment of this application;

FIG. 9 is a schematic diagram of a process of a method for calculating a content importance parameter value according to an embodiment of this application;

FIG. 10 is a schematic flowchart 3 of a bit allocation method for an audio object according to an embodiment of this application;

FIG. 11 is a schematic flowchart 4 of a bit allocation method for an audio object according to an embodiment of this application; and

FIG. 12 is a schematic diagram of a structure of a bit allocation apparatus for an audio object according to an embodiment of this application.

### DESCRIPTION OF EMBODIMENTS

The following describes some terms and technologies in this application.

(1) Audio Frame

Audio data is streaming. In an actual application, to facilitate audio processing and transmission, an amount of audio data within duration is usually used as a frame of audio, namely, an audio frame. The duration is referred to as a “sampling time”, and a value of the duration may be specifically determined based on a requirement of a codec and a specific application. For example, the duration is 2.5 ms to 60 ms, and ms is millisecond.

(2) Audio Object

An important way to implement three-dimensional audio is an object-based audio technology. In the object-based audio technology, each audio frame may include a plurality of audio objects. During encoding and decoding, encoding and decoding are separately performed on the plurality of audio objects.

In some scenes, an audio object may also be referred to as an object audio signal or an audio signal.

(3) Metadata (Metadata)

Metadata, also referred to as mediation data or relay data, is data about data (data about data). It is mainly used to describe a property (property) of data, and supports functions such as storage location and historical data indicating, resource searching, and file recording. Metadata is information about organization and a data domain of data, and their relationships.

(4) Other Terms

In embodiments of this application, the word “example” or “for example” is used to represent giving an example, an illustration, or a description. Any embodiment or design scheme described as an “example” or “for example” in embodiments of this application should not be explained as being more preferred or having more advantages than another embodiment or design scheme. Exactly, use of the word “example”, “for example”, or the like is intended to present a related concept in a specific manner.

The terms “first” and “second” in embodiments of this application are merely intended for a purpose of description, and shall not be understood as an indication or implication of relative importance or implicit indication of a quantity of indicated technical features. Therefore, a feature limited by “first” or “second” may explicitly or implicitly include one or more such features. In the descriptions of this application, unless otherwise stated, “a plurality of” means two or more than two.

In this application, the term “at least one” means one or more, and in this application, the term “a plurality of” means two or more. For example, a plurality of second packets mean two or more second packets.

It should be understood that the terms used in the descriptions of various examples in this specification are merely intended to describe specific examples, but are not intended to constitute a limitation. As used in the descriptions of the various examples and the appended claims, the terms “one (“a”, “an”)” and “the” of singular forms are intended to also include plural forms, unless otherwise explicitly indicated in the context.

It should be further understood that, the term “and/or” used in this specification indicates and includes any or all possible combinations of one or more items in associated listed items. The term “and/or” describes an association relationship between associated objects and indicates that three relationships may exist. For example, A and/or B may indicate the following three cases: Only A exists, both A and B exist, and only B exists. In addition, the character “/” in this application generally indicates an “or” relationship between associated objects.

It should be further understood that sequence numbers of processes do not mean execution sequences in embodiments of this application. The execution sequences of the processes should be determined based on functions and internal logic of the processes, and should not be construed as any limitation on the implementation processes of embodiments of this application.

It should be understood that determining B based on A does not mean that B is determined based on only A, and B may alternatively be determined based on A and/or other information.

It should be further understood that the term “include” (or referred to as “includes”, “including”, “comprises”, and/or “comprising”), when being used in this specification, specifies the presence of stated features, integers, operations, operations, elements, and/or components, but does not preclude the presence or addition of one or more other features, integers, operations, operations, elements, components, and/or groups thereof.

It should be further understood that the term “if” may be interpreted as a meaning “when” (“when” or “upon”), “in response to determining”, or “in response to detecting”. Similarly, according to the context, the phrase “if it is determined that” or “if (a stated condition or event) is detected” may be interpreted as a meaning of “when it is determined that”, “in response to determining”, “when (a stated condition or event) is detected”, or “in response to detecting (a stated condition or event)”.

It should be understood that, “one embodiment”, “some embodiments”, and “a possible implementation” mentioned in the entire specification mean that particular features, structures, or characteristics related to embodiments or implementations are included in at least one embodiment of this application. Therefore, “in an embodiment” or “in some embodiments”, and “a possible implementation” appearing throughout the specification do not necessarily refer to a same embodiment. In addition, these particular features, structures, or characteristics may be combined in one or more embodiments by using any appropriate manner.

In some embodiments, a bit allocation method for an audio object provided in embodiments of this application may be applied to a stereo encoder of a terminal. For example, the terminal may be a mobile terminal, a fixed network terminal, or the like.

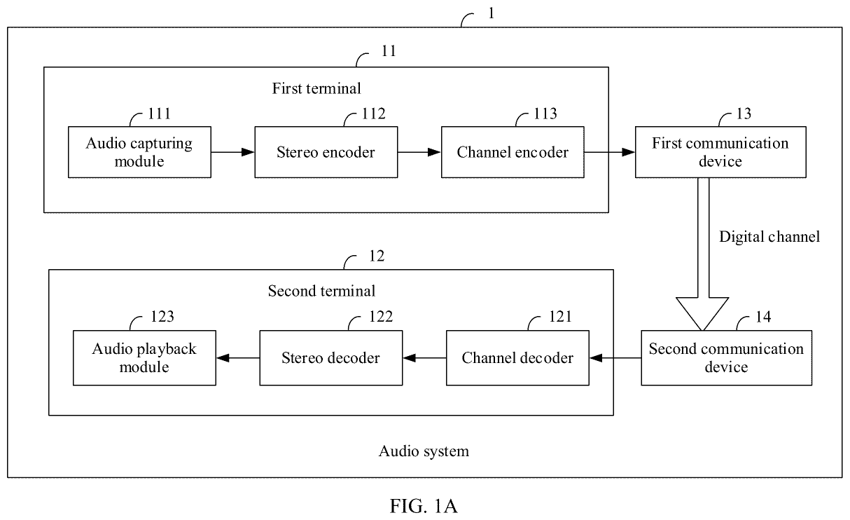

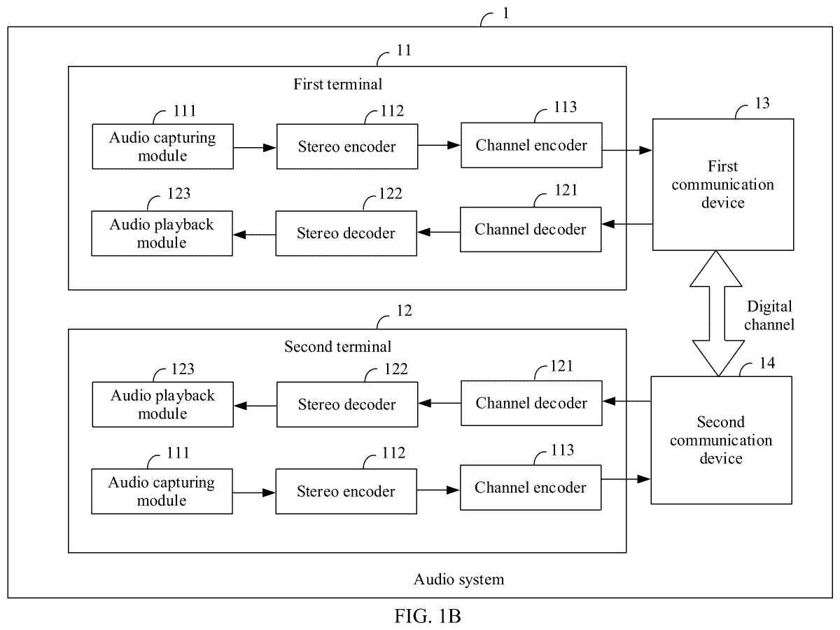

FIG. 1A is a schematic diagram of a structure of an audio system 1 to which a technical solution according to an embodiment of this application is applicable. The audio system 1 includes a first terminal 11 and a second terminal 12.

The first terminal 11 includes an audio capturing module 111, a stereo encoder 112, and a channel encoder 113. The second terminal 12 includes a channel decoder 121, a stereo decoder 122, and an audio playback module 123.

Based on FIG. 1A, in the first terminal 11, the audio capturing module 111 is configured to capture a stereo signal, and the stereo encoder 112 is configured to perform stereo encoding on the stereo signal. The channel encoder 113 is configured to perform channel encoding on a stereo-encoded signal. In one embodiment, after being processed by a first communication device 13, a channel-encoded signal is transmitted through a digital channel. After passing through a second communication device 14, the signal is transmitted to the second terminal 12. Either of the first communication device 13 and the second communication device 14 may be a wireless network communication device or a wired network communication device.

Based on FIG. 1A, in the second terminal 12, the channel decoder 121 is configured to perform channel decoding on a received signal. The stereo decoder 122 is configured to perform stereo decoding on a channel-decoded signal. The audio playback module 123 is configured to play back a stereo-decoded signal.

In FIG. 1A, the first terminal 11 and the first communication device 13 are transmit-side devices, and the second terminal 12 and the second communication device 14 are receive-side devices. In some scenarios, the first terminal 11 and the first communication device 13 may alternatively be used as receive-side devices, and correspondingly, the second terminal 12 and the second communication device 14 are used as transmit-side devices. In this case, the first terminal 11 may further include the channel decoder 121, the stereo decoder 122, and the audio playback module 123, and the second terminal 12 may further include the audio capturing module 111, the stereo encoder 112, and the channel encoder 113, as shown in FIG. 1B. For functions of the modules, refer to the foregoing descriptions. Details are not described herein again.

In some embodiments, the bit allocation method for an audio object provided in embodiments of this application may be applied to a stereo encoder of a network device (which includes a network device in a wireless network or a network device in a core network). For example, the network device may be a media gateway, a transcoding device, or a media resource server in a radio access network or a core network.

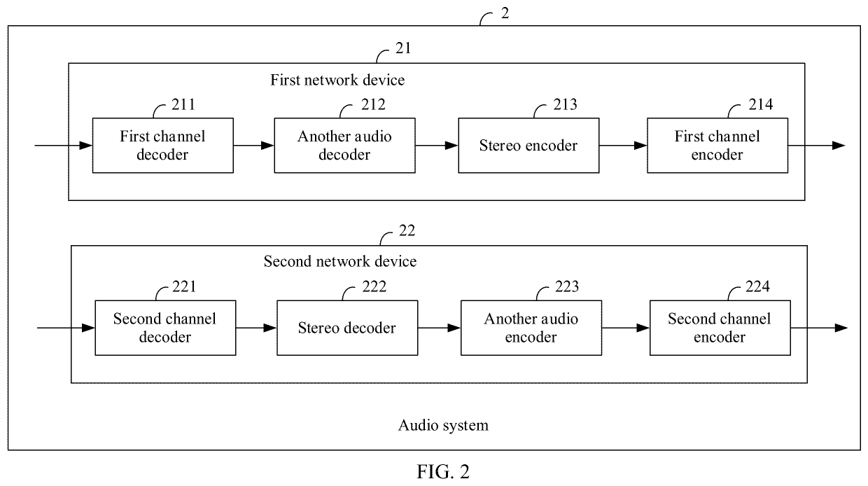

FIG. 2 is a schematic diagram of a structure of an audio system 2 to which a technical solution according to an embodiment of this application is applicable. The audio system 2 includes a first network device 21 and a second network device 22.

The first network device 21 includes a first channel decoder 211, another audio decoder 212, a stereo encoder 213, and a first channel encoder 214. The second network device 22 includes a second channel decoder 221, a stereo decoder 222, another audio encoder 223, and a second channel decoder 224.

In the first network device 21, the first channel decoder 211 is configured to perform channel decoding on a received signal. The another audio decoder 212 is configured to transcode a channel-decoded signal. The stereo encoder 213 is configured to perform stereo encoding on a transcoded signal. The first channel encoder 214 is configured to perform channel encoding on a stereo-encoded signal.

In the second network device 22, the second channel decoder 221 is configured to perform channel decoding on a received signal. The stereo decoder 222 is configured to perform stereo decoding on a channel-decoded signal. The another audio encoder 223 is configured to transcode a stereo-decoded signal. The second channel decoder 224 is configured to perform channel encoding on a transcoded signal.

It should be noted that stereo encoding and decoding processing may be a part for a multi-channel codec. For example, that an encoder side performs multi-channel encoding on a captured multi-channel signal may include: The encoder side performs downmixing processing on the captured multi-channel signal to obtain a stereo signal, and encodes the stereo signal. A decoder side decodes a bitstream based on a multi-channel signal to obtain a stereo signal, and performs upmixing processing on the stereo signal to restore the multi-channel signal.

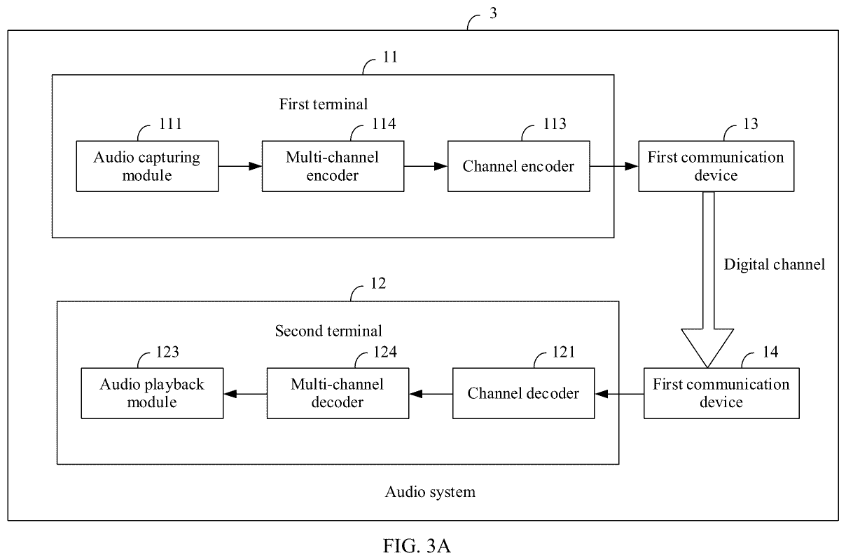

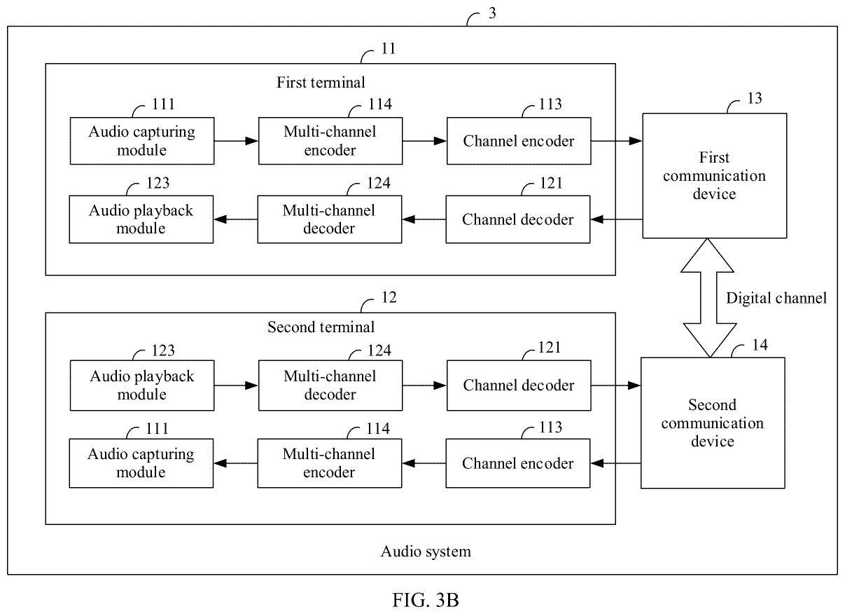

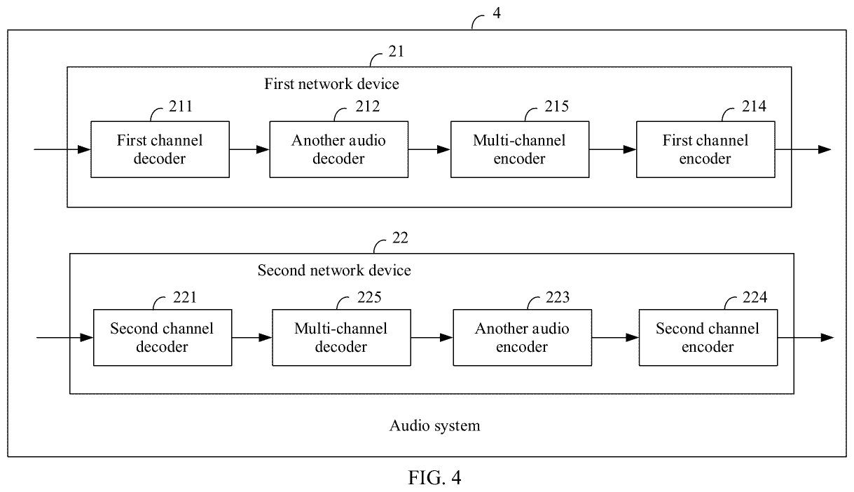

Based on this, the bit allocation method for an audio object provided in embodiments of this application may be further applied to a multi-channel encoder of a terminal. For an audio system in which the multi-channel encoder is located, refer to FIG. 3A or FIG. 3B. Alternatively, the bit allocation method for an audio object provided in embodiments of this application may be further applied to a multi-channel encoder of a network device (which includes a network device in a wireless network or a network device in a core network). For an audio system in which the multi-channel encoder is located, refer to FIG. 4.

FIG. 3A is a schematic diagram of a structure of an audio system 3 to which a technical solution according to an embodiment of this application is applicable. FIG. 3A is drawn based on FIG. 1A. Specifically, the stereo encoder 112 in FIG. 1A is replaced with a multi-channel encoder 114, and the stereo decoder 122 is replaced with a multi-channel decoder 124.

Based on FIG. 3A, in a first terminal 11, the audio capturing module 111 is configured to capture a multi-channel signal. The multi-channel encoder 114 is configured to perform multi-channel encoding on the multi-channel signal, including stereo encoding. The channel encoder 113 is configured to perform channel encoding on a multi-channel-encoded signal. After being processed by the first communication device 13, a channel-encoded signal is transmitted through a digital channel. After passing through the second communication device 14, the signal is transmitted to the second terminal 12.

Based on FIG. 3A, in the second terminal 12, the channel decoder 121 is configured to perform channel decoding on a received signal. The multi-channel decoder 124 is configured to perform multi-channel decoding on a channel-decoded signal, including stereo decoding. The audio playback module 123 is configured to play back a multi-channel-decoded signal.

FIG. 3B is a schematic diagram of another structure of the audio system 3 to which a technical solution according to an embodiment of this application is applicable. FIG. 3B is drawn based on FIG. 1B and FIG. 3A. Explanations of related content of FIG. 3B may be obtained through inference based on FIG. 1B and FIG. 3A and the foregoing text descriptions of FIG. 1B and FIG. 3A. Details are not described herein again.

FIG. 4 is a schematic diagram of a structure of an audio system 4 to which a technical solution according to an embodiment of this application is applicable. FIG. 4 is drawn based on FIG. 2. Specifically, the stereo encoder 213 in FIG. 2 is replaced with a multi-channel encoder 215, and the stereo decoder 223 is replaced with a multi-channel decoder 225. The multi-channel encoder 215 is configured to perform multi-channel encoding on a signal transcoded by the another audio decoder 212, including stereo encoding. The first channel encoder 214 is configured to perform channel encoding on a multi-channel-encoded signal. The multi-channel decoder 225 is configured to perform multi-channel decoding on a signal obtained through channel decoding by the second channel decoder 221, including stereo decoding. The another audio encoder 223 is configured to transcode a multi-channel-decoded signal. For a function of another module/component, refer to the foregoing description of the function of the corresponding module in FIG. 2. Details are not described herein again.

In some embodiments, the bit allocation method for an audio object provided in embodiments of this application may be applied to an audio encoder (audio encoder) in a virtual reality (virtual reality, VR) streaming (streaming) service. In this scenario, an end-to-end process of processing an audio object includes: A preprocessing operation (audio preprocessing) is performed after an audio object A passes through a capturing module (acquisition), where the preprocessing operation may include filtering out a low-frequency part from a signal, and usually extracting orientation information from the signal by using 20 Hz (hertz) or 50 Hz as a demarcation point, and then, an audio encoder performs encoding (audio encoding) and encapsulation (file/segment encapsulation). An encoded and encapsulated signal is delivered (delivery) to a decoder side. The decoder side decapsulates (file/segment decapsulation) the received signal, an audio decoder decodes (audio decoding) the signal, performs binaural rendering (audio rendering) on a decoded signal, and maps a rendered signal to a headset (headphones) of a listener. The headset may be an independent headset, or may be a headset on a glasses device, for example, an HTC VIVE.

Modules/components in any one of the foregoing audio systems are distinguished from a perspective of a logical function. Some or all of the foregoing modules/components may be implemented by using software, may be implemented by using hardware, or may be implemented by using software in combination with hardware.

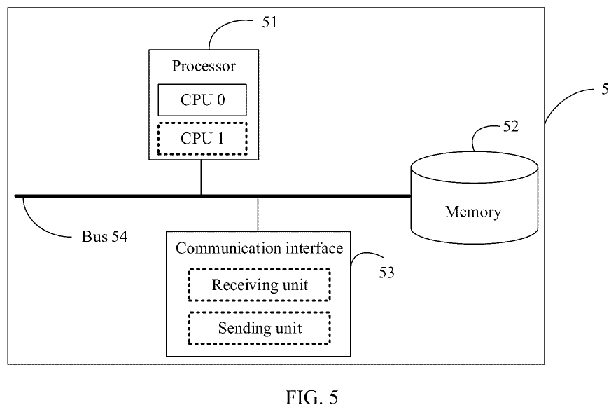

FIG. 5 is a schematic diagram of a hardware structure of a computer device 5 according to an embodiment of this application. The computer device 5 may be configured to perform the bit allocation method for an audio object provided in embodiments of this application.

In one embodiment, the computer device 5 may be configured to implement a function of the stereo encoder in FIG. 1A, FIG. 1B, or FIG. 2, or may be configured to implement a function of the multi-channel encoder in FIG. 3A, FIG. 3B, or FIG. 4.

In one embodiment, the computer device 5 may be configured to implement a function of the first terminal in FIG. 1A, a function of the first terminal or the second terminal in FIG. 1B, a function of the first network device in FIG. 2, a function of the first terminal in FIG. 3A, a function of the first terminal or the second terminal in FIG. 3B, or a function of the first network device in FIG. 4.

As shown in FIG. 5, the computer device 5 may include a processor 51, a memory 52, a communication interface 53, and a bus 54. The processor 51, the memory 52, and the communication interface 53 may be connected through the bus 54.

The processor 51 is a control center of the computer device 5, and may be a general-purpose central processing unit (central processing unit, CPU), another general-purpose processor, or the like. The general-purpose processor may be a microprocessor, any conventional processor, or the like.

In an example, the processor 51 may include one or more CPUs, for example, a CPU 0 and a CPU 1 shown in FIG. 5.

The memory 52 may be a read-only memory (read-only memory, ROM) or another type of static storage device capable of storing static information and instructions, a random access memory (random access memory, RAM) or another type of dynamic storage device capable of storing information and instructions, an electrically erasable programmable read-only memory (electrically erasable programmable read-only memory, EEPROM), a magnetic disk storage medium or another magnetic storage device, or any other medium capable of carrying or storing expected program code in a form of an instruction or data structure and capable of being accessed by a computer, but is not limited thereto.

In a possible implementation, the memory 52 may be independent of the processor 51. The memory 52 may be connected to the processor 51 through the bus 54, and is configured to store data, instructions, or program code. When invoking and executing the instructions or the program code stored in the memory 52, the processor 51 can implement the bit allocation method for an audio object provided in embodiments of this application.

In another possible implementation, the memory 52 may alternatively be integrated with the processor 51.

The communication interface 53 is configured to connect the computer device 5 to another device by using a communication network. The communication network may be an ethernet, a radio access network (radio access network, RAN), a wireless local area network (wireless local area network, WLAN), or the like. The communication interface 53 may include a receiving unit configured to receive data and a sending unit configured to send data.

The bus 54 may be an industry standard architecture (industry standard architecture, ISA) bus, a peripheral component interconnect (peripheral component, PCI) bus, an extended industry standard architecture (extended industry standard architecture, EISA) bus, or the like. The bus may be classified into an address bus, a data bus, a control bus, and the like. For ease of representation, only one bold line is used to represent the bus in FIG. 5, but this does not mean that there is only one bus or only one type of bus.

It should be noted that the structure shown in FIG. 5 does not constitute a limitation on the computer device. In addition to the components shown in FIG. 5, the computer device 5 may include more or fewer components than those shown in the figure, or some components may be combined, or there may be a different component layout.

The following describes the bit allocation method for an audio object provided in embodiments of this application with reference to the accompanying drawings. The method may be applied to an encoder. For example, the encoder may be the stereo encoder in FIG. 1A, FIG. 1B, or FIG. 2, may be the multi-channel encoder in FIG. 3A, FIG. 3B, or FIG. 4, or may be the audio encoder in the VR streaming service.

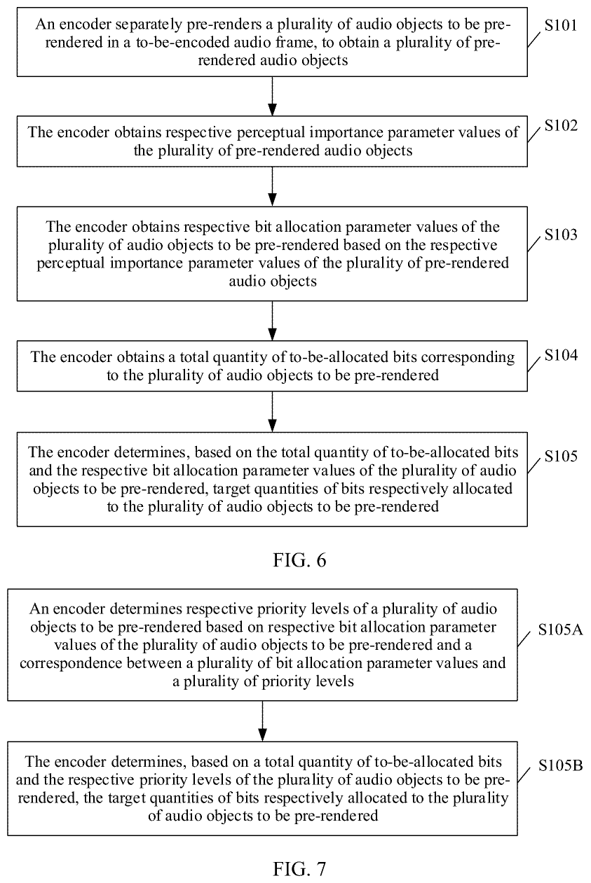

FIG. 6 is a schematic flowchart of the bit allocation method for an audio object according to an embodiment of this application. The method shown in FIG. 6 may include the following operations.

S101: The encoder separately pre-renders a plurality of audio objects to be pre-rendered in a to-be-encoded audio frame, to obtain a plurality of pre-rendered audio objects (pre-rendered audio objects). The audio objects to be pre-rendered are in a one-to-one correspondence with the pre-rendered audio objects.

The to-be-encoded audio frame may be any three-dimensional audio frame that has an encoding requirement. To distinguish between an audio object before pre-rendering and an audio object after pre-rendering, in this embodiment of this application, the audio object before pre-rendering is referred to as an audio object to be pre-rendered, and the audio object after pre-rendering is referred to as a pre-rendered audio object. A quantity of audio objects to be pre-rendered included in the to-be-encoded audio frame may be predefined. The “plurality of audio objects to be pre-rendered” in S101 may be some or all of the audio objects included in the to-be-encoded audio frame. It may be understood that, if the plurality of audio objects to be pre-rendered are a part of the audio objects included in the to-be-encoded audio frame, for a bit allocation method for another part of the audio objects, refer to the conventional technology.

A specific implementation of pre-rendering is not limited in this embodiment of this application. For example, a pre-rendering method may be a method used when an audio object is actually rendered, for example, a method based on a head related transfer function (head related transfer function, HRTF), or may be a low-complexity rendering method that can obtain a result with a feature similar to that of a result of actually rendering the audio object.

In one embodiment, metadata information used during pre-rendering is consistent with metadata information used during actual rendering (that is, the metadata information is the same or slightly different). In this way, perceptual importance parameter values that are of the plurality of pre-rendered audio objects and that are subsequently obtained by the encoder are closer to perceptual importance parameter values that are of a plurality of audio objects and that are actually obtained by a decoder through rendering, thereby helping improve overall quality and encoding efficiency of a reconstructed audio object after bit allocation is performed by using the technical solution.

S102: The encoder obtains respective perceptual importance parameter values of the plurality of pre-rendered audio objects.

A perceptual importance parameter value of a current pre-rendered audio object indicates a perceptual importance degree of the current pre-rendered audio object in the plurality of pre-rendered audio objects. The perceptual importance degree may include an energy intensity degree and/or a spectrum change degree. The current pre-rendered audio object may be any one of the plurality of pre-rendered audio objects.

A perceptual importance parameter of the current pre-rendered audio object may include a parameter indicating an energy intensity degree and/or a spectrum change degree of the current pre-rendered audio object in the plurality of pre-rendered audio objects within a period of time.

The perceptual importance degree may be measured by using one perceptual importance parameter, or may be measured by using a combination of a plurality of perceptual importance parameters.

That which specific parameter is the perceptual importance parameter is not limited in this embodiment of this application. For example, the perceptual importance parameter may include one or more of the following parameters (1) to (3).

(1) Energy importance parameter. An energy importance parameter of the current pre-rendered audio object is obtained through calculation based on energy of the current pre-rendered audio object, and indicates a ratio of the energy of the current pre-rendered audio object to a sum of respective energy of the plurality of pre-rendered audio objects. In one embodiment, the energy importance parameter of the current pre-rendered audio object may be the ratio, or a value obtained by performing mapping based on the ratio according to a preset algorithm. For example, mapping values corresponding to different ratios may be preset. For example, a value of an energy importance parameter in an interval of [0.8,0.9] may be mapped to 0.85 or 0.8. Alternatively, another mapping manner may be used. A specific mapping manner is not limited in this embodiment of the present disclosure.

(2) Perceptual intensity importance parameter. A perceptual intensity importance parameter of the current pre-rendered audio object is obtained through calculation based on an auditory curve of a human ear and energy of the current pre-rendered audio object, and indicates a ratio of a sum of energy of a preset quantity of frequency bands that have maximum energy and that are in a plurality of frequency bands of the current pre-rendered audio object to a sum of energy of a preset quantity of frequency bands that have maximum energy and that are in respective plurality of frequency bands of the plurality of pre-rendered audio objects. In one embodiment, the perceptual intensity importance parameter of the current pre-rendered audio object may be the ratio, or a value obtained by performing mapping based on the ratio. For a specific mapping manner, refer to the manner described in the energy importance parameter part.

The preset quantity of the frequency bands that have maximum energy and that are in the plurality of frequency bands may be a first preset quantity of frequency bands in a sequence obtained by sorting the plurality of frequency bands in descending order of energy, or a last preset quantity of frequency bands in a sequence obtained by sorting the plurality of frequency bands in ascending order of energy.

(3) Spectral flatness parameter. A spectral flatness parameter of the current pre-rendered audio object indicates spectral flatness of the current pre-rendered audio object in the plurality of pre-rendered audio objects.

In one embodiment, the perceptual importance parameter value of the current pre-rendered audio object may be obtained based on features of the plurality of pre-rendered audio objects, or may be obtained based on features of audio objects obtained by shaping the plurality of pre-rendered audio objects. The feature may be a time domain feature, may be a frequency domain feature, or may be a combination of a time domain feature and a frequency domain feature. The following uses an example in which the perceptual importance parameter value is obtained based on the features of the plurality of pre-rendered audio objects for description.

The following describes manners of obtaining the energy importance parameter, the perceptual intensity importance parameter, and the spectral flatness parameter by using examples.

(1) Energy importance parameter

In one embodiment, an energy importance parameter value of the current pre-rendered audio object may include a ratio of an energy value of the current pre-rendered audio object to a sum of respective energy values of the plurality of pre-rendered audio objects, or a parameter value determined based on a ratio of an energy value of the current pre-rendered audio object to a sum of respective energy values of the plurality of pre-rendered audio objects. The parameter value may be considered as a value obtained by processing (for example, mapping) the ratio. A specific processing manner is not limited in this embodiment of this application.

For example, an energy importance parameter value Eimpᵢ of an i^{th} pre-rendered audio object satisfies the following formula 1:

$${E\_imp}_{i} = {E}_{i} / {\sum }_{k = 1}^{N} {E}_{k} . \qquad Formula 1$$

Eᵢ indicates an energy value of the i^{th} pre-rendered audio object. 1≤i≤N, where N indicates a quantity of the pre-rendered audio objects in S102.

$${\sum }_{k = 1}^{N} {E}_{k}$$

indicates a total energy value of N pre-rendered audio objects. Eimpᵢ∈[0,1].

(2) Perceptual Intensity Importance Parameter

In one embodiment, a perceptual intensity importance parameter value of the current pre-rendered audio object may be obtained based on frequency band perceptual intensity parameter values of some or all frequency bands of the current pre-rendered audio object. A frequency band perceptual intensity parameter value of a frequency band is obtained through calculation based on an auditory curve of a human ear and energy of the frequency band, and indicates energy strength of the frequency band in the current pre-rendered audio object.

For example, a perceptual intensity importance parameter value Intensi tiympᵢ of the i^{th} pre-rendered audio object may be obtained by using the following operations.

(a): The encoder calculates a frequency band perceptual intensity parameter value of each frequency band of the i^{th} pre-rendered audio object.

Specifically, the encoder divides a frequency domain resource of the i^{th} pre-rendered audio object into a plurality of frequency bands, and then obtains respective frequency band perceptual intensity parameter values of the plurality of frequency bands. How to divide a frequency band is not limited in this embodiment of this application. For example, a frequency band perceptual intensity parameter value pᵢ(b) of a frequency band b of the plurality of frequency bands satisfies the following formula 2:

pᵢ(b)=Eᵢ(b)−T(b). Formula 2:

Eᵢ(b) indicates an energy value of a frequency band b of the i^{th} pre-rendered audio object, T(b) is a constant factor calculated in the frequency band b based on the auditory curve of the human ear, and a value of the constant factor may be obtained through summarizing based on experimental experience. For example, T(b)=3.84×(b_{f}/1000)−^{0.8}−6.5×e^{-0.6(b}^{_{f}}^{/1000-3.3)}^{²}+10³×(b_{f}/1000)⁴. b_{f} indicates a center frequency value corresponding to a center frequency of the frequency band b.

According to the formula 2, the encoder can obtain the frequency band perceptual intensity parameter value of each frequency band of the i^{th} pre-rendered audio object.

(b): The encoder sorts the frequency band perceptual intensity parameter value of each frequency band obtained in (a) in descending order to obtain a set Pᵢ(b) shown in Formula 3:

Pᵢ(b)≡{pᵢ(b₁),pᵢ(b₂), . . . ,pᵢ(b_{L})}. Formula 3:

Pᵢ(b) indicates a set of sorted frequency band perceptual intensity parameter values of the i^{th} pre-rendered audio object, pᵢ(bⱼ)≥pᵢ(bₖ), ∀<k, j, k∈{1, 2, . . . , L}, and L indicates a quantity of frequency bands obtained by dividing the i^{th} pre-rendered audio object.

(c): The encoder obtains the perceptual intensity importance parameter value of the i^{th} pre-rendered audio object based on the set Pᵢ(b).

For example, the encoder selects a first 1 value in the set Pᵢ(b), and the 1 value and Intensi tiympᵢ satisfy the following formula 4:

Intensi tiympᵢ=Σⱼ₌₁¹pᵢ(bⱼ)/Σₙ₌₁^{N}Σⱼ₌₁¹pₙ(bⱼ). Formula 4:
1≤L, and Intensi tiympᵢ∈[0,1].

(3) Spectral Flatness Parameter

For example, a spectral flatness parameter value Flatnessmpiᵢ of the i^{th} pre-rendered audio object satisfies the following formula 5:

Flatnessmpiᵢ=Σₖ₌₁^{B}−Rᵢ(k)·log₁₀Rᵢ(k)/Σₙ₌₁^{N}Σₖ₌₁^{B}−Rₙ(k)·log₁₀Rₙ(k). Formula 5:

Rᵢ(k)=Eᵢ(k)/Eᵢ, Eᵢ(k) indicates an energy value of a k^{th} frequency band of the i^{th} pre-rendered audio object, and B is a quantity of frequency bands of the i^{th} pre-rendered audio object. Flatnessmpiᵢ∈[0,1].

S103: The encoder obtains respective bit allocation parameter values of the plurality of audio objects to be pre-rendered based on the respective perceptual importance parameter values of the plurality of pre-rendered audio objects.

A bit allocation parameter of a current audio object to be pre-rendered indicates a target quantity of bits allocated to the current audio object to be pre-rendered. The current audio object to be pre-rendered may be any one of the plurality of audio objects to be pre-rendered. In other words, the encoder can obtain a respective bit allocation parameter value of each of the plurality of audio objects to be pre-rendered in a manner of obtaining a bit allocation parameter value of the current audio object to be pre-rendered.

In one embodiment, a predefined rule is met between the perceptual importance parameter value of the current pre-rendered audio object and the bit allocation parameter value of the current audio object to be pre-rendered. The rule may be represented by using a function, or may not be represented by using a function. The current pre-rendered audio object is obtained by pre-rendering the current audio object to be pre-rendered. The encoder can determine the bit allocation parameter value of the current audio object to be pre-rendered based on the rule and the perceptual importance parameter value of the current pre-rendered audio object.

The following uses an example in which the rule is represented by using a function to describe obtaining a bit allocation parameter value of an i^{th} audio object to be pre-rendered.

In some implementations, when there are a plurality of perceptual importance parameters of the i^{th} pre-rendered audio object, the encoder may introduce a parameter ImportantPᵢ in a process of calculating the bit allocation parameter value of the i^{th} audio object to be pre-rendered. The parameter ImportantPᵢ indicates an overall perceptual importance degree of the i^{th} pre-rendered audio object in N audio objects to be pre-rendered. In comparison, different perceptual importance parameter values of the i^{th} pre-rendered audio object indicate perceptual importance degrees of the i^{th} pre-rendered audio object at different angles in the N audio objects to be pre-rendered.

In one embodiment, a value of ImportantPᵢ may be obtained by performing a specific operation on the perceptual importance parameter values. For example, the value of ImportantPᵢ may satisfy the following formula 6:

ImportantPᵢ=f(parm_p_{i_1},parm_p_{i_2}, . . . ,parm_p_{i_m}). Formula 6:

parm_p_{i_j} indicates kith perceptual importance parameter value of the i^{th} pre-rendered audio object. 1≤j≤m, where m is a quantity of the perceptual importance parameters of the i^{th} pre-rendered audio object.

In one embodiment, a function relationship represented by the formula 6 may be linear or non-linear.

When the perceptual importance parameter includes the energy importance parameter, the perceptual intensity importance parameter, and the spectral flatness parameter, the foregoing formula 6 may be specifically expressed as the following formula 7:

ImportantPᵢ=f(Eimpᵢ,Imtensitiympᵢ,Flatnessmpiᵢ). Formula 7:

In one embodiment, a function relationship represented by the formula 7 may be linear or non-linear.

For example, the foregoing formula 7 may be specifically represented as the following formula 8:

ImportantPᵢ=a₁·Eᵢₘₚ_{ᵢ}+a₂·Intensityᵢₘₚ_{ᵢ}+a₃·Flatnessᵢₘₚ_{ᵢ}. Formula 8:

a₁, a₂, and a₃ are constants, and values of a₁, a₂, and a₃ may be obtained through experimental experience.

In one embodiment, a₁, a₂, and a₃ satisfy the following formula 9:

a₁+a₂+a₃=1, where a₁,a₂,a₃∈[0,1]. Formula 9:

In one embodiment, the bit allocation parameter value ImportantBitᵢ of the i^{th} audio object to be pre-rendered satisfies the following formula 10:

ImportantBitᵢ=f(ImportantPᵢ) Formula 10:

In one embodiment, a function relationship represented by the formula 10 may be linear or non-linear.

In one embodiment, the bit allocation parameter value of the current audio object to be pre-rendered may include a first ratio, or a parameter value determined based on a first ratio. The first ratio is a ratio of the perceptual importance parameter value of the current pre-rendered audio object to a sum of the respective perceptual importance parameter values of the plurality of pre-rendered audio objects.

Specifically, S103 may include: The encoder first uses the ratio of the perceptual importance parameter value of the current pre-rendered audio object to the sum of the respective perceptual importance parameter values of the plurality of pre-rendered audio objects as the first ratio, and then uses the first ratio as the bit allocation parameter value of the current audio object to be pre-rendered, or determines a parameter value based on the first ratio, and uses the parameter value as the bit allocation parameter value of the current audio object to be pre-rendered. The parameter value may be considered as a value obtained by processing the first ratio. A specific processing manner is not limited in this embodiment of this application.

For example, the formula 10 may be further represented as the following formula 11:

ImportantBitᵢ=ImportantPᵢ/Σₖ₌₁^{N}ImportantPₖ. Formula 11:

It can be learned that, in this example, ImportantBitᵢ∈[0,1].

In some other implementations, the encoder may not introduce the parameter ImportantPᵢ in a process of obtaining the bit allocation parameter value ImportantBitᵢ of the i^{th} audio object to be pre-rendered. For example, the foregoing formula 10 may be replaced with the following formula 12:

ImportantBitᵢ=f(parm_p_{i_1},parm_p_{i_2}, . . . ,parm_p_{i_m}). Formula 12:

In one embodiment, a function relationship represented by the formula 12 may be linear or non-linear.

When the perceptual importance parameter includes the energy importance parameter, the perceptual intensity importance parameter, and the spectral flatness parameter, the foregoing formula 12 may be specifically expressed as the following formula 13:

ImportantBitᵢ=f(E_Impᵢ,Intensitiympᵢ,Flatnessmpiᵢ). Formula 13:

A specific representation form of the formula 13 is not limited in this embodiment of this application.

S104: The encoder obtains a total quantity of to-be-allocated bits corresponding to the plurality of audio objects to be pre-rendered.

The total quantity of to-be-allocated bits is a total quantity of bits allocated to the plurality of audio objects to be pre-rendered. The total quantity of to-be-allocated bits is learned by the encoder in advance. For a specific implementation, refer to the conventional technology. How the encoder learns the total quantity of to-be-allocated bits in advance is not limited in this embodiment of this application. For example, the total quantity of to-be-allocated bits may be indicated by a user, or may be predefined.

S105: The encoder determines, based on the total quantity of to-be-allocated bits and the respective bit allocation parameter values of the plurality of audio objects to be pre-rendered, target quantities of bits respectively allocated to the plurality of audio objects to be pre-rendered.

Specifically, the encoder determines, based on the total quantity of to-be-allocated bits and the bit allocation parameter value of the current audio object to be pre-rendered, the target quantity of bits allocated to the current audio object to be pre-rendered.

In some implementations, a ratio of the target quantity of bits allocated to the current audio object to be pre-rendered to the total quantity of to-be-allocated bits is equal to a third ratio, or is equal to a parameter value determined based on a third ratio. The third ratio is a ratio of the bit allocation parameter value of the current audio object to be pre-rendered to a sum of the respective bit allocation parameter values of the plurality of audio objects to be pre-rendered. The parameter value may be considered as a value obtained by processing the third ratio. A specific processing manner is not limited in this embodiment of this application.

Specifically, the encoder first uses the ratio of the bit allocation parameter value of the current audio object to be pre-rendered to the sum of the respective bit allocation parameter values of the plurality of audio objects to be pre-rendered as the third ratio, and then uses a product of the third ratio and the total quantity of to-be-allocated bits as the target quantity of bits allocated to the current audio object to be pre-rendered, or obtains a parameter value based on the third ratio, and uses a product of the parameter value and the total quantity of to-be-allocated bits as the target quantity of bits allocated to the current audio object to be pre-rendered. The parameter value may be a value obtained by the encoder by processing the third ratio. A processing manner is not limited in this embodiment of this application.

For example, if “the ratio of the target quantity of bits allocated to the current audio object to be pre-rendered to the total quantity of to-be-allocated bits is equal to a third ratio”, the target quantity of bits allocated to the current audio object to be pre-rendered may be determined by a product of the bit allocation parameter value of the current audio object to be pre-rendered and the total quantity of to-be-allocated bits.

For example, the current audio object to be pre-rendered is the i^{th} audio object to be pre-rendered. A target quantity of bits Bits_object₁ allocated to the i^{th} audio object to be pre-rendered may be obtained by using the following formula 14:

Bits_object₁=ImportantBit₁*Bitsavailable. Formula 14:

Bitavailable indicates the total quantity of to-be-allocated bits.

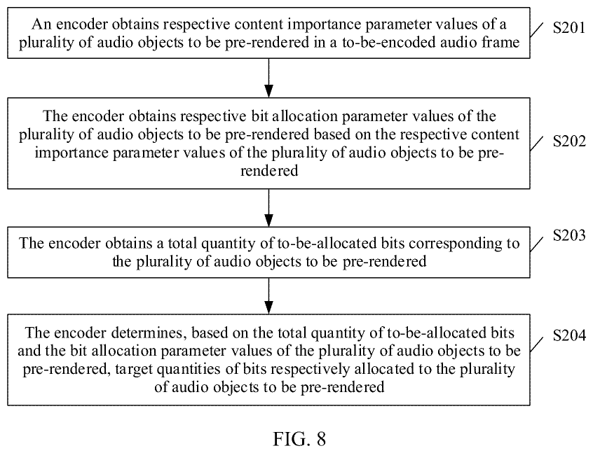

In some other implementations, as shown in FIG. 7, S105 may include the following S105A and S105B.

S105A: The encoder determines respective priority levels of the plurality of audio objects to be pre-rendered based on a correspondence between a plurality of bit allocation parameter values and a plurality of priority levels and the respective bit allocation parameter values of the plurality of audio objects to be pre-rendered.

Specifically, the encoder determines a priority level of the current audio object to be pre-rendered based on the correspondence between the plurality of bit allocation parameter values and the plurality of priority levels and the bit allocation parameter value of the current audio object to be pre-rendered.

In an implementation, the encoder determines the respective priority levels of the plurality of audio objects to be pre-rendered based on a correspondence between intervals within which the plurality of bit allocation parameter values fall and the plurality of priority levels, and the respective bit allocation parameter values of the plurality of audio objects to be pre-rendered.

Specifically, the encoder determines the priority level of the current audio object to be pre-rendered based on the correspondence between the intervals within which the plurality of bit allocation parameter values fall and the plurality of priority levels, and the bit allocation parameter value of the current audio object to be pre-rendered.

The correspondence between the intervals within which the plurality of bit allocation parameter values fall and the plurality of priority levels may be predefined. In this embodiment of this application, a quantity of levels included in a priority level and an interval within which a bit allocation parameter value corresponding to each priority level falls are not limited, and may be specifically determined based on an actual requirement.

In one embodiment, a higher priority level corresponds to a larger target quantity of bits. For example, Table 1 shows an example of the correspondence between the intervals within which the plurality of bit allocation parameter values fall and the plurality of priority levels.

TABLE 1

| Interval within which a bit | |
|---|---|
| allocation parameter value falls | Priority level |
| [0.9, 1] | 10 |
| [0.8, 0.9) | 9 |
| [0.7, 0.8) | 8 |
| [0.6, 0.7) | 7 |
| [0.5, 0.6) | 6 |
| [0.4, 0.5) | 5 |
| [0.3, 0.4) | 4 |
| [0.2, 0.3) | 3 |
| [0.1, 0.2) | 2 |
| [0, 0.1) | 1 |

In one embodiment, a higher priority level corresponds to a smaller target quantity of bits. For example, priority levels 10 to 1 in Table 1 may be replaced with priority levels 1 to 10.

In this implementation, different bit allocation parameter values falling within a same interval correspond to a same priority level.

In another implementation, the encoder approximates the respective bit allocation parameter values of the plurality of audio objects to be pre-rendered to corresponding preset values based on a processing manner, for example, one or more of closing, removing, or rounding off, and then determines the respective priority levels of the plurality of audio objects to be pre-rendered based on a correspondence between a plurality of preset values and the plurality of priority levels.

Specifically, the encoder approximates the bit allocation parameter value of the current audio object to be pre-rendered to a preset value, and then determines the priority level of the current audio object to be pre-rendered based on the correspondence between the plurality of preset values and the plurality of priority levels.

In this implementation, different bit allocation parameter values corresponding to a same preset value may correspond to a same priority level.

S105B: The encoder determines, based on the total quantity of to-be-allocated bits and the respective priority levels of the plurality of audio objects to be pre-rendered, the target quantities of bits respectively allocated to the plurality of audio objects to be pre-rendered.

Specifically, the encoder determines, based on the total quantity of to-be-allocated bits and the respective priority levels of the plurality of audio objects to be pre-rendered, the target quantity of bits allocated to the current audio object to be pre-rendered.

In one embodiment, a ratio of the target quantity of bits allocated to the current audio object to be pre-rendered to the total quantity of to-be-allocated bits is equal to a fourth ratio, or is equal to a parameter value determined based on a fourth ratio. The fourth ratio is a ratio of the priority level of the current audio object to be pre-rendered to a sum of the respective priority levels of the plurality of audio objects to be pre-rendered. The parameter value may be considered as a value obtained by processing the fourth ratio. A specific processing manner is not limited in this embodiment of this application.

Specifically, the encoder first uses the ratio of the priority level of the current audio object to be pre-rendered to the sum of the respective priority levels of the plurality of audio objects to be pre-rendered as the fourth ratio, and then uses a product of the fourth ratio and the total quantity of to-be-allocated bits as the target quantity of bits allocated to the current audio object to be pre-rendered, or determines a parameter value based on the fourth ratio, and uses a product of the parameter value and the total quantity of to-be-allocated bits as the target quantity of bits allocated to the current audio object to be pre-rendered.

For example, it is assumed that the plurality of audio objects to be pre-rendered are audio objects to be pre-rendered 1 to 3, and bit allocation parameter values of the audio objects to be pre-rendered 1 to 3 are respectively 0.6, 0.25, and 0.15, it can be learned based on Table 1 that priority levels of the audio objects to be pre-rendered 1 to 3 are respectively 7, 3, and 2, and a total quantity of to-be-allocated bits corresponding to the three audio objects to be pre-rendered is Bits_avaiblle. In this case, percentages of target quantities of bits allocated to the audio objects to be pre-rendered 1 to 3 in Bits_avaaiblle are respectively

$$\frac{7}{7 + 3 + 2} = \frac{7}{12} , \frac{3}{7 + 3 + 2} = \frac{3}{12} , and \frac{2}{7 + 3 + 2} = \frac{2}{12} .$$

It can be learned that the target quantities of bits allocated to the audio objects to be pre-rendered 1 to 3 are respectively

$$\frac{7}{12} * Bits\_available , \frac{3}{12} * Bits\_available , and \frac{2}{12} * Bits\_available .$$

According to the bit allocation method for an audio object provided in this embodiment, when a quantity of bits is allocated to an audio object to be pre-rendered, a difference between perceptual characteristics of different pre-rendered audio objects at a rendering playback end is considered. Compared with a technical solution in a conventional technology in which different audio objects are encoded by using a same quantity of bits, this helps improve overall quality of a reconstructed audio object. For example, a higher perceptual importance degree indicated by a perceptual importance parameter value of a pre-rendered audio object indicates a larger quantity of bits that the encoder may allocate to an audio object to be pre-rendered (namely, an audio object of the pre-rendered audio object before pre-rendering) corresponding to the pre-rendered audio object, and the quantity of bits may be used to encode the audio object to be pre-rendered. In this case, quality of an audio object reconstructed by the decoder is higher. This helps improve overall quality of a reconstructed audio frame including a plurality of audio objects. In addition, this can improve encoding efficiency.

FIG. 8 is another schematic flowchart of the bit allocation method for an audio object according to an embodiment of this application. For explanations of related terms in this embodiment, refer to the embodiment shown in FIG. 6. The method shown in FIG. 8 may include the following operations.

S201: The encoder obtains respective content importance parameter values of a plurality of audio objects to be pre-rendered in a to-be-encoded audio frame.

A content importance parameter value of a current audio object to be pre-rendered indicates an importance degree of a sound type represented by content of the current audio object to be pre-rendered in sound types represented by content of the plurality of audio objects to be pre-rendered.

It should be noted that sound types represented by respective content of the current audio object remain unchanged before and after pre-rendering. Therefore, a content importance parameter of the current audio object to be pre-rendered is equivalent to a content importance parameter of a current pre-rendered audio object. A content importance parameter value of the current pre-rendered audio object indicates an importance degree of a sound type represented by content of the current pre-rendered audio object in sound types represented by content of a plurality of pre-rendered audio objects.

In one embodiment, the sound type may include at least one of the following: voice, music, sound effect, ambient sound, noise, and the like. Certainly, during actual implementation, the sound type may be classified in another manner.

It is relative that a type of sound has a higher importance degree and a type of sound has a lower importance degree. A manner of determining the type of sound is not limited in this embodiment of this application, and the type of sound may be specifically determined based on an actual requirement. For example, importance degrees of sound types in descending order may be defined as follows: voice, music, sound effect, ambient sound, and noise.

The content importance parameter value of the current audio object to be pre-rendered may be obtained from metadata of the to-be-encoded audio frame, obtained from a feature of the current audio object to be pre-rendered, or obtained from a feature of an audio object obtained by shaping the current audio object to be pre-rendered.

In some implementations, the respective content importance parameter values of the plurality of audio objects to be pre-rendered that are obtained from the metadata of the to-be-encoded audio frame may be represented as the following formula 15:

ImportantC≡{I_C₁,I_C₂, . . . ,I_C_{N}}. Formula 15:

{I_C₁, I_C₂, . . . , I_C_{N}} indicate content importance parameter values of N audio objects to be pre-rendered that are obtained from the metadata of the to-be-encoded audio frame, and are all constants. For example, each value in {I_C₁, I_C₂, . . . , I_C_{N}} falls within (0,1].

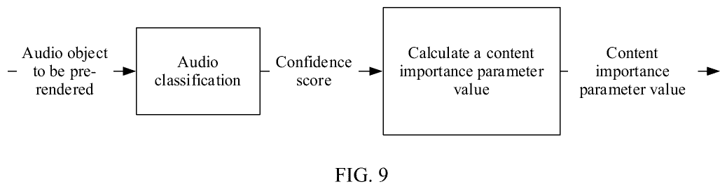

In some other implementations, as shown in FIG. 9, it is assumed that the importance degrees of the sound types in descending order are predefined as follows: voice, music, sound effect, ambient sound, and noise, the encoder may obtain, by using a known audio classifier, confidence scores indicating that sound types represented by respective content of the plurality of audio objects to be pre-rendered are voice, that is, obtain a plurality of confidence scores corresponding to the plurality of audio objects to be pre-rendered, where one audio object to be pre-rendered corresponds to one confidence score. Then, for each audio object to be pre-rendered, the encoder calculates a content importance parameter value of the audio object to be pre-rendered based on a correspondence between a confidence score corresponding to the audio object to be pre-rendered and a content importance parameter value.

It may be understood that this implementation may be summarized as: A confidence score indicating that a sound type represented by content of an audio object to be pre-rendered is voice distinguishes (or reflects) whether a sound represented by the content of the audio object to be pre-rendered is voice, music, sound effect, an ambient sound, noise, or the like, to determine a content importance parameter value of the audio object to be pre-rendered.

For example, a content importance parameter value ImportantCᵢ of an i^{th} audio object to be pre-rendered may satisfy the following formula 16:

ImportantCᵢ=1/(1+e^{A·P_C}^{ᵢ}^{+B}). Formula 16:

P_Cᵢ indicates a confidence score indicating that the i^{th} audio object to be pre-rendered is a voice, and P_Cᵢ∈(0,1]. A and B are constant factors, and are used to make Important_Cᵢ∈(0,1].

S202: The encoder obtains respective bit allocation parameter values of the plurality of audio objects to be pre-rendered based on the respective content importance parameter values of the plurality of audio objects to be pre-rendered.

For example, a bit allocation parameter value ImportantBitᵢ of the i^{th} audio object to be pre-rendered satisfies the following formula 17:

ImportantBitᵢ=f(ImportantCᵢ). Formula 17:

In one embodiment, a function relationship represented by the formula 17 may be linear or non-linear.

In one embodiment, the bit allocation parameter value of the current audio object to be pre-rendered includes a ratio, or a parameter value determined based on a ratio. The ratio is a ratio of a perceptual importance parameter value of the current pre-rendered audio object to a sum of respective perceptual importance parameter values of the plurality of pre-rendered audio objects. The parameter value may be considered as a value obtained by processing the ratio. A specific processing manner is not limited in this embodiment of this application.

For example, the formula 17 may be further represented as the following formula 18:

$${Important\_Bit}_{i} = \frac{{Important\_C}_{i}}{{\sum }_{k = 1}^{N} {Important\_C}_{k}} . \qquad Formula 18$$

It can be learned that, in this example, ImportantBitᵢ∈[0,1].

S203: The encoder obtains a total quantity of to-be-allocated bits corresponding to the plurality of audio objects to be pre-rendered.

For related explanations and examples of S203, refer to S104. Details are not described herein again.

S204: The encoder determines, based on the total quantity of to-be-allocated bits and the respective bit allocation parameter values of the plurality of audio objects to be pre-rendered, target quantities of bits respectively allocated to the plurality of audio objects to be pre-rendered.

For related explanations and examples of S204, refer to S105. Details are not described herein again.

According to the bit allocation method for an audio object provided in this embodiment, when a quantity of bits is allocated to an audio object to be pre-rendered, a difference between content features of different audio objects to be pre-rendered is considered. Compared with a technical solution in a conventional technology in which different audio objects are encoded by using a same quantity of bits, this helps improve overall quality of a reconstructed audio object. For example, if a higher content importance degree indicated by a content importance parameter of an audio object to be pre-rendered indicates a larger quantity of bits that the encoder may allocate to the audio object to be pre-rendered, and the quantity of bits may be used for encoding. In this case, quality of an audio object reconstructed by a decoder is higher. This helps improve overall quality of a reconstructed audio frame including a plurality of audio objects. In addition, this can improve encoding efficiency.

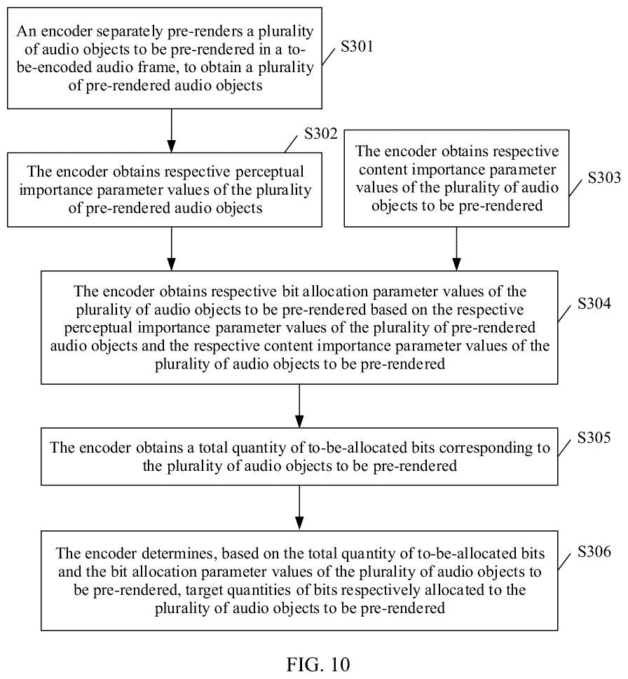

FIG. 10 is still another schematic flowchart of the bit allocation method for an audio object according to an embodiment of this application. For explanations of related content in this embodiment, refer to the embodiments shown in FIG. 6 and FIG. 8. The method shown in FIG. 10 may include the following operations.

S301: The encoder separately pre-renders a plurality of audio objects to be pre-rendered in a to-be-encoded audio frame, to obtain a plurality of pre-rendered audio objects. The audio objects are in a one-to-one correspondence with the pre-rendered audio objects.

S302: The encoder obtains respective perceptual importance parameter values of the plurality of pre-rendered audio objects.

For related explanations and examples of S301 and S302, refer to S101 and S102.

Details are not described herein again.

S303: The encoder obtains respective content importance parameter values of the plurality of audio objects to be pre-rendered.

For related explanations and examples of S303, refer to S201.

A performing sequence of S301 and S302, and S303 is not limited in this embodiment of this application. For example, S301 and S302 may be performed before S303, S303 may be performed before S301 and S302, or S301 and S302, and S303 may be simultaneously performed.

S304: The encoder obtains respective bit allocation parameter values of the plurality of audio objects to be pre-rendered based on the respective perceptual importance parameter values of the plurality of pre-rendered audio objects and the respective content importance parameter values of the plurality of audio objects to be pre-rendered.

Specifically, the encoder obtains a bit allocation parameter value of a current audio object to be pre-rendered based on a perceptual importance parameter value of a current pre-rendered audio object and a content importance parameter value of the current audio object to be pre-rendered.

For example, a bit allocation parameter value ImportantBitᵢ of an i^{th} audio object to be pre-rendered satisfies the following formula 19:

ImportantBitᵢ=f(ImportantPᵢ,ImportantCᵢ). Formula 19:

In one embodiment, a function relationship represented by the formula 19 may be linear or non-linear.

In one embodiment, the bit allocation parameter value of the current audio object to be pre-rendered includes a second ratio, or a parameter value determined based on a second ratio. The second ratio is a ratio of a first value of the current audio object to be pre-rendered to a sum of respective first values of the plurality of audio objects to be pre-rendered. The parameter value may be considered as a value obtained by processing the second ratio. A specific processing manner is not limited in this embodiment of this application. The first value of the current audio object to be pre-rendered is a product of the content importance parameter value of the current audio object to be pre-rendered and the perceptual importance parameter value of the current pre-rendered audio object, or the first value of the current audio object to be pre-rendered is a parameter value determined based on “a product of the content importance parameter value of the current audio object to be pre-rendered and the perceptual importance parameter value of the current pre-rendered audio object”. The parameter value may be considered as a value obtained by processing the product. A specific processing manner is not limited in this embodiment of this application.

Specifically, S304 may include: The encoder first uses the ratio of the first value of the current audio object to be pre-rendered to the sum of the respective first values of the plurality of audio objects to be pre-rendered as the second ratio, and then uses the second ratio as the bit allocation parameter value of the current audio object to be pre-rendered, or determines a parameter value based on the second ratio, and uses the parameter value as the bit allocation parameter value of the current audio object to be pre-rendered.

For example, the formula 19 may be further represented as the following formula 20:

$${Important\_Bit}_{i} = \frac{{Important\_P}_{i} * {Important\_C}_{i}}{{\sum }_{k = 1}^{N} ( {Important\_P}_{k} * {Important\_C}_{k} )} . \qquad Formula 20$$

It can be learned that, in this example, ImportantBitᵢ∈[0,1].

S305: The encoder obtains a total quantity of to-be-allocated bits corresponding to the plurality of audio objects to be pre-rendered.

For related explanations and examples of S305, refer to S104. Details are not described herein again.

S306: The encoder determines, based on the total quantity of to-be-allocated bits and the respective bit allocation parameter values of the plurality of audio objects to be pre-rendered, target quantities of bits respectively allocated to the plurality of audio objects to be pre-rendered.

For related explanations and examples of S306, refer to S105. Details are not described herein again.

According to the bit allocation method for an audio object provided in this embodiment, when a quantity of bits is allocated to a pre-rendered audio object, a difference between perceptual characteristics of different pre-rendered audio objects at a rendering playback end and a difference between content of different audio objects to be pre-rendered are considered. Compared with a technical solution in a conventional technology in which different audio objects are encoded by using a same quantity of bits, this helps improve overall quality of a reconstructed audio object. In addition, this can improve encoding efficiency.

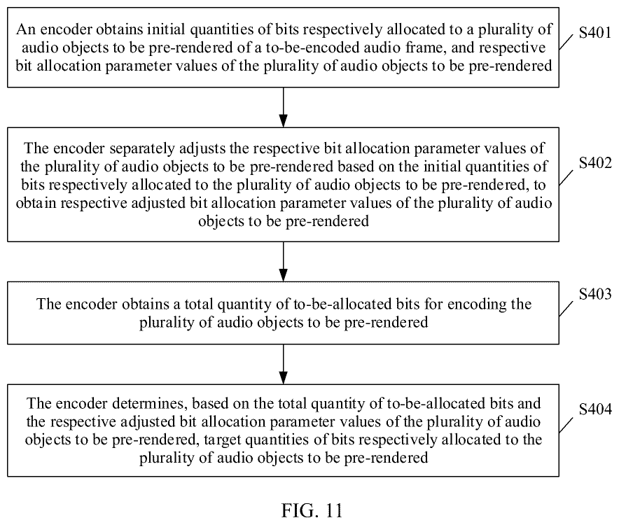

FIG. 11 is yet another schematic flowchart of the bit allocation method for an audio object according to an embodiment of this application. The method shown in FIG. 11 may include the following operations.

S401: The encoder obtains initial quantities of bits respectively allocated to a plurality of audio objects to be pre-rendered of a to-be-encoded audio frame, and respective bit allocation parameter values of the plurality of audio objects to be pre-rendered.

For example, a relationship between the initial quantities of bits that are respectively allocated to the plurality of audio objects to be pre-rendered and that are obtained by the encoder may be represented as the following formula 21:

Bit₁+Bit₂+ . . . +Bit_{N}=Bits_available. Formula 21:

Bit₁, Bit₂, . . . , and Bit_{N} respectively indicate initial quantities of bits that are obtained by using a known method and that are allocated to a 1^{st} audio object to be pre-rendered, a 2^{nd} audio object to be pre-rendered, . . . , and an N^{th} audio object to be pre-rendered in N audio objects to be pre-rendered. Bits_available indicates a total quantity of to-be-allocated bits.

How the encoder obtains the initial quantities of bits respectively allocated to the plurality of audio objects to be pre-rendered is not limited in this embodiment of this application. For example, the encoder may evenly allocate the total quantity of to-be-allocated bits to the plurality of audio objects to be pre-rendered, to obtain respective initial quantities of bits corresponding to the plurality of objects to be pre-rendered. For another example, the encoder may determine, based on respective energy of the plurality of audio objects to be pre-rendered, the initial quantities of bits respectively allocated to the plurality of audio objects to be pre-rendered. For still another example, the initial quantities of bits respectively allocated to the plurality of audio objects to be pre-rendered may be predefined.

In one embodiment, related explanations of the bit allocation parameter value in S401 are related explanations of the bit allocation parameter value in the embodiment shown in FIG. 6, FIG. 8, or FIG. 10. Details are not described herein again.

In addition, the encoder may obtain, based on respective content importance parameter values of the plurality of audio objects to be pre-rendered, the initial quantities of bits respectively allocated to the plurality of audio objects to be pre-rendered. In this case, the encoder may obtain the respective bit allocation parameter values of the plurality of audio objects to be pre-rendered by using the method in the embodiment shown in FIG. 8 or FIG. 10.

S402: The encoder separately adjusts the respective bit allocation parameter values of the plurality of audio objects to be pre-rendered based on the initial quantities of bits respectively allocated to the plurality of audio objects to be pre-rendered, to obtain respective adjusted bit allocation parameter values of the plurality of audio objects to be pre-rendered.

Specifically, the encoder adjusts a bit allocation parameter value of a current audio object to be pre-rendered based on an initial quantity of bits respectively allocated to the current audio object to be pre-rendered, to obtain a respective adjusted bit allocation parameter value of the current audio object to be pre-rendered.

In one embodiment, an adjusted bit allocation parameter value Adjustᵢ of an i^{th} audio object to be pre-rendered after modulation, a bit allocation parameter value Adjust_inofᵢ of the i^{th} audio object to be pre-rendered, and an initial quantity of bits Bitᵢ allocated to the i^{th} audio object to be pre-rendered may satisfy the following formula 22:

Adjustᵢ=f(Adjustnifoᵢ,Bitᵢ). Formula 22:

In other words, Adjustᵢ is obtained by using a function relationship based on Adjust_inofᵢ and Bitᵢ. The function relationship may be linear or non-linear.

Further In one embodiment, the adjusted bit allocation parameter value of the current audio object to be pre-rendered includes a fifth ratio or a parameter value determined based on a fifth ratio. The fifth ratio is a ratio of a second value of the current audio object to be pre-rendered to a sum of respective second values of the plurality of audio objects to be pre-rendered. The parameter value may be considered as a value obtained by processing the fifth ratio. A specific processing manner is not limited in this embodiment of this application. The second value of the current audio object to be pre-rendered is a product of the initial quantity of bits allocated to the current audio object to be pre-rendered and the bit allocation parameter value of the current audio object to be pre-rendered, or a parameter value determined based on “a product of the initial quantity of bits allocated to the current audio object to be pre-rendered and the bit allocation parameter value of the current audio object to be pre-rendered”. The parameter value may be considered as a value obtained by processing the product. A specific processing manner is not limited in this embodiment of this application.

Specifically, the encoder first uses the ratio of the second value of the current audio object to be pre-rendered to the sum of the respective second values of the plurality of audio objects to be pre-rendered as the fifth ratio, and then uses the fifth ratio as the adjusted bit allocation parameter value of the current audio object to be pre-rendered, or determines a parameter value based on the fifth ratio, and uses the parameter value as the adjusted bit allocation parameter value of the current audio object to be pre-rendered.

For example, the formula 22 may be further represented as the following formula 23:

Adjustᵢ=Adjust_inofᵢ·Bitᵢ/Σₖ₌₁^{N}(Adjust_inofₖ·Bitₖ) Formula 23:

S403: The encoder obtains a total quantity of to-be-allocated bits for encoding the plurality of audio objects to be pre-rendered.

For related explanations and examples of S403, refer to S104. Details are not described herein again.

S404: The encoder determines, based on the total quantity of to-be-allocated bits and the respective adjusted bit allocation parameter values of the plurality of audio objects to be pre-rendered, target quantities of bits respectively allocated to the plurality of audio objects to be pre-rendered.

In one embodiment, a ratio of a target quantity of bits allocated to the current audio object to be pre-rendered to the total quantity of to-be-allocated bits is equal to the adjusted bit allocation parameter value of the current audio object to be pre-rendered, or is equal to a parameter value determined based on the adjusted bit allocation parameter value of the current audio object to be pre-rendered. The parameter value may be considered as a value obtained by processing the adjusted bit allocation parameter value of the current audio object to be pre-rendered. A specific processing manner is not limited in this embodiment of this application.

For example, a target quantity of bits Adjust_Bitᵢ allocated to the i^{th} audio object to be pre-rendered satisfies the following formula 24:

Adjust_Bitᵢ=Adjustᵢ·Bits_available. Formula 24:

In one embodiment, the respective bit allocation parameter values of the plurality of audio objects to be pre-rendered obtained in S501 are determined based on perceptual importance parameter values. Based on this, the foregoing formula 22 may be specifically represented as the following formula 25:

Adjustᵢ=f(Important_Pᵢ,Bitᵢ). Formula 25:

The foregoing formula 23 may be specifically represented as the following formula 26:

Adjustᵢ=ImportantPᵢ·Bitᵢ/Σₖ₌₁^{N}(ImportantPₖ·Bitₖ). Formula 26:

According to the bit allocation method for an audio object provided in this embodiment, the respective bit allocation parameter values of the plurality of audio objects to be pre-rendered are respectively adjusted based on the initial quantities of bits respectively allocated to the plurality of audio objects to be pre-rendered, and the target quantities of bits respectively allocated to the plurality of audio objects to be pre-rendered are determined based on the respective adjusted bit allocation parameter values of the plurality of audio objects to be pre-rendered. This helps further improve overall quality of a reconstructed audio object. In addition, this improves encoding efficiency.

It should be noted that, when no conflict occurs, some or all features in any plurality of the foregoing embodiments may be combined, to form a new embodiment.

In one embodiment, based on the bit allocation method for an audio object provided in any one of the embodiments provided above, the encoder may further send, to the decoder, proportion information of the target quantities of bits respectively allocated to the plurality of audio objects to be pre-rendered. The proportion information is used by the decoder to reconstruct the plurality of audio objects to be pre-rendered.

A specific implementation of the proportion information is not limited in this embodiment of this application. For example, the proportion information may be a proportion between the target quantities of bits respectively allocated to the plurality of audio objects to be pre-rendered. For another example, the proportion information may be the target quantities of bits respectively allocated to the plurality of audio objects to be pre-rendered.

After receiving the proportion information, the decoder may determine, based on the total quantity of to-be-allocated bits corresponding to the plurality of audio objects to be pre-rendered and the proportion information, bits in a bitstream (namely, a bitstream obtained by encoding the plurality of audio objects to be pre-rendered) corresponding to the plurality of audio objects to be pre-rendered for an audio object to be pre-rendered, to further reconstruct a specific audio object to be pre-rendered by using bits for the specific audio objects to be pre-rendered.

For example, it is assumed that the bitstream that is corresponding to the plurality of audio objects to be pre-rendered and that is sent by the encoder to the decoder includes 100 bits, the to-be-encoded audio frame includes audio objects to be pre-rendered 1 to 3, and the proportion information sent by the encoder to the decoder is 3:3:4, where “3:3:4” indicates a proportion between target quantities of bits respectively allocated to the audio objects to be pre-rendered 1 to 3, the decoder may determine, based on the 100 bits and “3:3:4”, that bits 1 to 30, bits 31 to 60, and bits 61 to 100 in the 100 bits (marked as bits 1 to 100) are respectively bits allocated to the audio objects to be pre-rendered 1 to 3 in sequence. Then, the audio object to be pre-rendered 1 is reconstructed by using the bits 1 to 30, the audio object to be pre-rendered 2 is reconstructed by using the bits 31 to 60, and the audio object to be pre-rendered 3 is reconstructed by using the bits 61 to 100. For a reconstruction process, refer to the conventional technology. Details are not described herein again.

The foregoing mainly describes the solutions provided in embodiments of this application from a perspective of a method. To implement the foregoing functions, corresponding hardware structures and/or software modules for performing the functions are included. A person skilled in the art should easily be aware that, in combination with units and algorithm operations of the examples described in embodiments disclosed in this specification, this application may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments of this application, a bit allocation apparatus (for example, an encoder or an encoding device) for an audio object may be divided into function modules based on the foregoing method examples. For example, each function module may be obtained through division based on each corresponding function, or two or more functions may be integrated into one processing module. The integrated module may be implemented in a form of hardware, or may be implemented in a form of a software function module. It should be noted that, in embodiments of this application, module division is an example, and is merely a logical function division. During actual implementation, another division manner may be used.

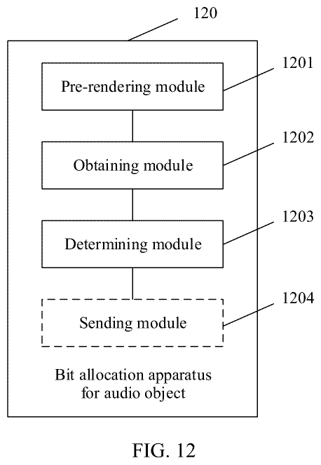

FIG. 12 is a schematic diagram of a structure of a bit allocation apparatus 120 for an audio object according to an embodiment of this application. The bit allocation apparatus 120 for an audio object is configured to perform the foregoing bit allocation method for an audio object, for example, perform the bit allocation method for an audio object shown in FIG. 6, FIG. 8, FIG. 10, or FIG. 11. For example, the bit allocation apparatus 120 for an audio object includes a pre-rendering module 1201, an obtaining module 1202, and a determining module 1203.

The pre-rendering module 1201 is configured to separately pre-render a plurality of audio objects to be pre-rendered in a to-be-encoded audio frame, to obtain a plurality of pre-rendered audio objects. The obtaining module 1202 is configured to: obtain respective perceptual importance parameter values of the plurality of pre-rendered audio objects, where a perceptual importance parameter value of a current pre-rendered audio object in the plurality of pre-rendered audio objects indicates a perceptual importance degree of the current pre-rendered audio object in the plurality of pre-rendered audio objects; and obtain a bit allocation parameter value of a current audio object to be pre-rendered in the audio objects to be pre-rendered based on the respective perceptual importance parameter values of the plurality of pre-rendered audio objects. The determining module 1203 is configured to determine, based on the bit allocation parameter value of the current audio object to be pre-rendered and a total quantity of to-be-allocated bits corresponding to the plurality of audio objects to be pre-rendered, a target quantity of bits allocated to the current audio object to be pre-rendered.

For example, with reference to FIG. 6, the pre-rendering module 1201 may be configured to perform S101, the obtaining module 1202 may be configured to perform S102 to S104, and the determining module 1203 may be configured to perform S105.

In one embodiment, the perceptual importance degree includes at least one of an energy intensity degree and a spectrum change degree.

In one embodiment, a perceptual importance parameter includes an energy importance parameter. An energy importance parameter of the current pre-rendered audio object is obtained through calculation based on energy of the current pre-rendered audio object, and indicates a ratio of the energy of the current pre-rendered audio object to a sum of respective energy of the plurality of pre-rendered audio objects.

In one embodiment, the perceptual importance parameter includes a perceptual intensity importance parameter. A perceptual intensity importance parameter of the current pre-rendered audio object is obtained through calculation based on an auditory curve of a human ear and energy of the current pre-rendered audio object, and indicates a ratio of a sum of energy of a preset quantity of frequency bands that have maximum energy and that are in a plurality of frequency bands of the current pre-rendered audio object to a sum of energy of a preset quantity of frequency bands that have maximum energy and that are in respective plurality of frequency bands of the plurality of pre-rendered audio objects.

In one embodiment, the perceptual importance parameter includes a spectral flatness parameter. A spectral flatness parameter of the current pre-rendered audio object indicates spectral flatness of the current pre-rendered audio object in the plurality of pre-rendered audio objects.

In one embodiment, the current pre-rendered audio object is an audio object obtained by pre-rendering the current audio object to be pre-rendered. The bit allocation parameter value of the current audio object to be pre-rendered includes a first ratio, or a parameter value determined based on a first ratio. The first ratio is a ratio of the perceptual importance parameter value of the current pre-rendered audio object to a sum of the respective perceptual importance parameter values of the plurality of pre-rendered audio objects.

In one embodiment, the obtaining module 1202 is further configured to obtain respective content importance parameter values of the plurality of audio objects to be pre-rendered. A content importance parameter value of the current audio object to be pre-rendered indicates an importance degree of a sound type represented by content of the current audio object to be pre-rendered in sound types represented by content of the plurality of audio objects to be pre-rendered. In an aspect of obtaining the bit allocation parameter value of the current audio object to be pre-rendered based on the respective perceptual importance parameter values of the plurality of pre-rendered audio objects, the obtaining module is specifically configured to obtain the bit allocation parameter value of the current audio object to be pre-rendered based on the respective perceptual importance parameter values of the plurality of pre-rendered audio objects and the respective content importance parameter values of the plurality of audio objects to be pre-rendered. For example, with reference to FIG. 10, the obtaining module 1202 may be configured to perform S303 and S304.

In one embodiment, the current pre-rendered audio object is an audio object obtained by pre-rendering the current audio object to be pre-rendered. The bit allocation parameter value of the current audio object to be pre-rendered includes a second ratio, or a parameter value determined based on a second ratio. The second ratio is a ratio of a first value of the current audio object to be pre-rendered to a sum of respective first values of the plurality of audio objects to be pre-rendered. The first value of the current audio object to be pre-rendered is a product of the content importance parameter value of the current audio object to be pre-rendered and the perceptual importance parameter value of the current pre-rendered audio object, or the first value of the current audio object to be pre-rendered is a parameter value determined based on a product of the content importance parameter value of the current audio object to be pre-rendered and the perceptual importance parameter value of the current pre-rendered audio object.

In one embodiment, the sound type includes at least one of the following: voice, music, sound effect, ambient sound, or noise.

In one embodiment, a ratio of the target quantity of bits allocated to the current audio object to be pre-rendered to the total quantity of to-be-allocated bits is equal to a third ratio, or is equal to a parameter value determined based on a third ratio. The third ratio is a ratio of the bit allocation parameter value of the current audio object to be pre-rendered to a sum of respective bit allocation parameter values of the plurality of audio objects to be pre-rendered.

In one embodiment, the determining module 1203 is specifically configured to: determine a priority level of the current audio object to be pre-rendered based on the bit allocation parameter value of the current audio object to be pre-rendered and a correspondence between a plurality of bit allocation parameter values and a plurality of priority levels; and then determine, based on the priority level of the current audio object to be pre-rendered and the total quantity of to-be-allocated bits, the target quantity of bits allocated to the current audio object to be pre-rendered.

For example, with reference to FIG. 7, the determining module 1203 may be configured to perform S105A and S105B.

In one embodiment, a ratio of the target quantity of bits allocated to the current audio object to be pre-rendered to the total quantity of to-be-allocated bits is equal to a fourth ratio, or is equal to a parameter value determined based on a fourth ratio. The fourth ratio is a ratio of the priority level of the current audio object to be pre-rendered to a sum of respective priority levels of the plurality of audio objects to be pre-rendered.

In one embodiment, the obtaining module 1202 is further configured to obtain an initial quantity of bits allocated to the current audio object to be pre-rendered. In this case, the determining module 1203 is specifically configured to: adjust the bit allocation parameter value of the current audio object to be pre-rendered based on the initial quantity of bits; and then determine, based on the total quantity of to-be-allocated bits and an adjusted bit allocation parameter value of the current audio object to be pre-rendered, the target quantity of bits allocated to the current audio object to be pre-rendered.

For example, with reference to FIG. 11, the obtaining module 1202 may be configured to perform the operation of obtaining the initial quantity of bits in S401. The determining module 1203 may be configured to perform S402 and S404.

In one embodiment, the adjusted bit allocation parameter value of the current audio object to be pre-rendered includes a fifth ratio or a parameter value determined based on a fifth ratio. The fifth ratio is a ratio of a second value of the current audio object to be pre-rendered to a sum of respective second values of the plurality of audio objects to be pre-rendered. The second value of the current audio object to be pre-rendered is a product of the initial quantity of bits and the bit allocation parameter value of the current audio object to be pre-rendered, or the second value of the current audio object to be pre-rendered is a parameter value determined based on a product of the initial quantity of bits and the bit allocation parameter value of the current audio object to be pre-rendered.

In one embodiment, the ratio of the target quantity of bits allocated to the current audio object to be pre-rendered to the total quantity of to-be-allocated bits is equal to the adjusted bit allocation parameter value of the current audio object to be pre-rendered, or is equal to a parameter value determined based on the adjusted bit allocation parameter value of the current audio object to be pre-rendered.

In one embodiment, as shown in FIG. 12, the bit allocation apparatus 120 for an audio object further includes: a sending module 1204, configured to send proportion information of target quantities of bits respectively allocated to the plurality of audio objects to be pre-rendered. The proportion information is used to reconstruct the plurality of audio objects to be pre-rendered.

For specific descriptions of the foregoing optional manners, refer to the foregoing method embodiments. Details are not described herein again. In addition, for any one of explanations and descriptions of beneficial effects of the bit allocation apparatus 120 for an audio object provided above, refer to the foregoing corresponding method embodiments. Details are not described again.

In an example, with reference to FIG. 1A or FIG. 1B, the bit allocation apparatus 120 for an audio object may be the stereo encoder 112. With reference to FIG. 2, the bit allocation apparatus 120 for an audio object may be the stereo encoder 213. With reference to FIG. 3A or FIG. 3B, the bit allocation apparatus 120 for an audio object may be the multi-channel encoder 114. With reference to FIG. 4, the bit allocation apparatus 120 for an audio object may be the multi-channel encoder 215.

In an example, with reference to FIG. 1A or FIG. 3A, the bit allocation apparatus 120 for an audio object may be the first terminal 11. With reference to FIG. 1B or FIG. 3B, the bit allocation apparatus 120 for an audio object may be the first terminal 11 or the second terminal 12. With reference to FIG. 2 or FIG. 4, the bit allocation apparatus 120 for an audio object may be the first network device 21.

In an example, with reference to FIG. 5, some or all functions implemented by the pre-rendering module 1201, the obtaining module 1202, and the determining module 1203 may be implemented by the processor 51 in FIG. 5 by executing the program code in the memory 52 in FIG. 2. The sending module 1204 may be implemented by using the receiving unit in the communication interface 53 in FIG. 5.

An embodiment of this application further provides an audio system, including an encoding apparatus and a decoding apparatus. The encoding apparatus may be any bit allocation apparatus 120 for an audio object provided above. The decoding apparatus is configured to receive information sent by the encoding apparatus, and perform a decoding process (which includes a process of reconstructing an audio object).

An embodiment of this application further provides a computer-readable storage medium. The computer-readable storage medium stores a computer program. When the computer program is run on a computer, the computer is enabled to perform any one of the methods performed by the encoder provided above.

For explanations of related content and descriptions of beneficial effects in any one of the audio system and the computer-readable storage medium provided above, refer to the foregoing corresponding embodiments. Details are not described herein again.

An embodiment of this application further provides a chip. A control circuit and one or more ports that are configured to implement a function of the bit allocation apparatus 120 for an audio object are integrated into the chip. In one embodiment, for a function supported by the chip, refer to the foregoing description. Details are not described herein again. A person of ordinary skill in the art may understand that all or some of the operations of the foregoing embodiments may be implemented by a program instructing related hardware. The program may be stored in a computer-readable storage medium. The storage medium mentioned above may be a read-only memory, a random access memory, or the like. The processing unit or the processor may be a central processing unit, a general-purpose processor, an application-specific integrated circuit (application-specific integrated circuit, ASIC), a microprocessor (digital signal processor, DSP), a field-programmable gate array (field-programmable gate array, FPGA), or another programmable logic device, a transistor logic device, a hardware component, or any combination thereof.

An embodiment of this application further provides a computer program product including instructions. When the instructions are run on a computer, the computer is enabled to perform any method in the foregoing embodiments. The computer program product includes one or more computer instructions. When the computer program instruction is loaded and executed on a computer, all or some of the procedures or functions according to embodiments of this application are generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable medium accessible by a computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, an SSD), or the like.

It should be noted that the foregoing components that are provided in embodiments of this application and that are configured to store the computer instructions or the computer program, for example, but not limited to the foregoing memory, computer-readable storage medium, and communication chip, are all non-transitory (non-transitory).

In a process of implementing this application that claims protection, a person skilled in the art may understand and implement other variations of the disclosed embodiments by viewing the accompanying drawings, the disclosed content, and the appended claims. In the claims, “comprising” (comprising) does not exclude another component or another operation, and “a” or “one” does not exclude a case of plurality. A single processor or another unit may implement several functions enumerated in the claims. Some measures are recorded in dependent claims that are different from each other, but this does not mean that these measures cannot be combined to produce better effect. Although this application is described with reference to specific features and embodiments thereof, various modifications and combinations may be made to them without departing from the spirit and scope of this application. Correspondingly, the specification and accompanying drawings are merely example description of this application defined by the appended claims, and are considered as any of or all modifications, variations, combinations or equivalents that cover the scope of this application.

1. A bit allocation method for an audio object, comprising:
separately pre-rendering a plurality of audio objects to be pre-rendered in a to-be-encoded audio frame, to obtain a plurality of pre-rendered audio objects;
obtaining a plurality of perceptual importance parameter values of the plurality of pre-rendered audio objects, each pre-rendered audio object of the plurality of pre-rendered audio objects having a respective perceptual importance parameter value of the plurality of perceptual importance parameter values, wherein a perceptual importance parameter value of the plurality of perceptual importance parameter values of a current pre-rendered audio object in the plurality of pre-rendered audio objects indicates a perceptual importance degree of the current pre-rendered audio object in the plurality of pre-rendered audio objects;
obtaining a bit allocation parameter value of a current audio object to be pre-rendered in the plurality of audio objects to be pre-rendered based on a respective perceptual importance parameter value of the plurality of perceptual importance parameter values of the plurality of pre-rendered audio objects; and
determining, based on the bit allocation parameter value of the current audio object to be pre-rendered and a total quantity of to-be-allocated bits corresponding to the plurality of audio objects to be pre-rendered, a target quantity of bits allocated to the current audio object to be pre-rendered.

2. The method according to claim 1, wherein a perceptual importance parameter value of the plurality of perceptual importance parameter values comprises at least one of: an energy importance parameter value, a perceptual intensity importance parameter value, or a spectral flatness parameter value, wherein
an energy importance parameter value of the current pre-rendered audio object is obtained through calculation based on energy of the current pre-rendered audio object, and indicates a ratio of the energy of the current pre-rendered audio object to a sum of respective energy of the plurality of pre-rendered audio objects;
a perceptual intensity importance parameter value of the current pre-rendered audio object is obtained through calculation based on an auditory curve of a human ear and energy of the current pre-rendered audio object, and indicates a ratio of a sum of energy of a preset quantity of frequency bands that have maximum energy and that are in a plurality of frequency bands of the current pre-rendered audio object to a sum of energy of a preset quantity of frequency bands that have maximum energy and that are in respective plurality of frequency bands of the plurality of pre-rendered audio objects; and
a spectral flatness parameter value of the current pre-rendered audio object indicates spectral flatness of the current pre-rendered audio object in the plurality of pre-rendered audio objects.

3. The method according to claim 1, wherein the current pre-rendered audio object is an audio object obtained by pre-rendering the current audio object to be pre-rendered, and the bit allocation parameter value of the current audio object to be pre-rendered comprises a first ratio, or a parameter value determined based on the first ratio; and
wherein the first ratio is a ratio of the perceptual importance parameter value of the current pre-rendered audio object to a sum of the plurality of perceptual importance parameter values of the plurality of pre-rendered audio objects.

4. The method according to claim 1, the method further comprising:
obtaining a plurality of content importance parameter values of the plurality of audio objects to be pre-rendered, each audio object of the plurality of audio objects to be pre-rendered having a respective content importance parameter value of the plurality of content importance parameter values, wherein a content importance parameter value of the plurality of content importance parameter values of the current audio object to be pre-rendered indicates an importance degree of a sound type represented by content of the current audio object to be pre-rendered in sound types represented by content of the plurality of audio objects to be pre-rendered; and
wherein the obtaining the bit allocation parameter value of the current audio object to be pre-rendered in the plurality of audio objects to be pre-rendered based on a respective perceptual importance parameter value of the plurality of perceptual importance parameter values of the plurality of pre-rendered audio objects comprises:
obtaining the bit allocation parameter value of the current audio object to be pre-rendered based on a respective perceptual importance parameter value of the plurality of perceptual importance parameter values of the plurality of pre-rendered audio objects and a respective content importance parameter value of the plurality of content importance parameter values of the plurality of audio objects to be pre-rendered.

5. The method according to claim 4, wherein the current pre-rendered audio object is an audio object obtained by pre-rendering the current audio object to be pre-rendered, and the bit allocation parameter value of the current audio object to be pre-rendered comprises a second ratio, or a parameter value determined based on the second ratio; and
wherein the second ratio is a ratio of a first value of the current audio object to be pre-rendered to a sum of a plurality of first values of the plurality of audio objects to be pre-rendered, and the first value of the current audio object to be pre-rendered is a product of the respective content importance parameter value of the current audio object to be pre-rendered and the respective perceptual importance parameter value of the current pre-rendered audio object, or the first value of the current audio object to be pre-rendered is a parameter value determined based on a product of the respective content importance parameter value of the current audio object to be pre-rendered and the respective perceptual importance parameter value of the current pre-rendered audio object.

6. The method according to claim 4, wherein the sound type comprises at least one of voice, music, sound effect, ambient sound, or noise.

7. The method according to claim 1, wherein a ratio of the target quantity of bits allocated to the current audio object to be pre-rendered to the total quantity of to-be-allocated bits is equal to a third ratio, or is equal to a parameter value determined based on the third ratio; and
wherein the third ratio is a ratio of the bit allocation parameter value of the current audio object to be pre-rendered to a sum of a plurality of bit allocation parameter values of the plurality of audio objects to be pre-rendered.

8. The method according to claim 1, wherein the determining, based on the bit allocation parameter value of the current audio object to be pre-rendered and the total quantity of to-be-allocated bits corresponding to the plurality of audio objects to be pre-rendered, the target quantity of bits allocated to the current audio object to be pre-rendered comprises:
determining a priority level of the current audio object to be pre-rendered based on the bit allocation parameter value of the current audio object to be pre-rendered and a correspondence between a plurality of bit allocation parameter values and a plurality of priority levels; and
determining, based on the priority level of the current audio object to be pre-rendered and the total quantity of to-be-allocated bits, the target quantity of bits allocated to the current audio object to be pre-rendered.

9. The method according to claim 8, wherein a ratio of the target quantity of bits allocated to the current audio object to be pre-rendered to the total quantity of to-be-allocated bits is equal to a fourth ratio, or is equal to a parameter value determined based on the fourth ratio; and
wherein the fourth ratio is a ratio of the priority level of the current audio object to be pre-rendered to a sum of the plurality of priority levels of the plurality of audio objects to be pre-rendered.

10. The method according to claim 1, wherein the determining, based on the bit allocation parameter value of the current audio object to be pre-rendered and the total quantity of to-be-allocated bits corresponding to the plurality of audio objects to be pre-rendered, the target quantity of bits allocated to the current audio object to be pre-rendered comprises:
obtaining an initial quantity of bits allocated to the current audio object to be pre-rendered;
adjusting the bit allocation parameter value of the current audio object to be pre-rendered based on the initial quantity of bits; and
determining, based on the total quantity of to-be-allocated bits and an adjusted bit allocation parameter value of the current audio object to be pre-rendered, the target quantity of bits allocated to the current pre-rendered audio object.

11. The method according to claim 10, wherein the adjusted bit allocation parameter value of the current audio object to be pre-rendered comprises a fifth ratio or a parameter value determined based on the fifth ratio; and
wherein the fifth ratio is a ratio of a second value of a plurality of second values of the current audio object to be pre-rendered to a sum of the plurality of second values of the plurality of audio objects to be pre-rendered, and the second value of the current audio object to be pre-rendered is a product of the initial quantity of bits and the bit allocation parameter value of the current audio object to be pre-rendered, or the second value of the current audio object to be pre-rendered is a parameter value determined based on a product of the initial quantity of bits and the bit allocation parameter value of the current audio object to be pre-rendered.

12. The method according to claim 11, wherein the ratio of the target quantity of bits used by the current audio object to be pre-rendered to the total quantity of to-be-allocated bits is equal to the adjusted bit allocation parameter value of the current audio object to be pre-rendered, or is equal to a parameter value determined based on the adjusted bit allocation parameter value of the current audio object to be pre-rendered.

13. The method according to claim 1, the method further comprising:
sending a plurality of proportion information of target quantities of bits respectively allocated to the plurality of audio objects to be pre-rendered, wherein the plurality of proportion information is used to reconstruct the plurality of audio objects to be pre-rendered.

14. A bit allocation apparatus for an audio object, comprising:
a pre-rendering module, configured to separately pre-render a plurality of audio objects to be pre-rendered in a to-be-encoded audio frame, to obtain a plurality of pre-rendered audio objects;
an obtaining module, configured to: obtain a plurality of perceptual importance parameter values of the plurality of pre-rendered audio objects, each pre-rendered audio object of the plurality of pre-rendered audio objects having a respective perceptual importance parameter value of the plurality of perceptual importance parameter values, wherein a perceptual importance parameter value of the plurality of perceptual importance parameter values of a current pre-rendered audio object in the plurality of pre-rendered audio objects indicates a perceptual importance degree of the current pre-rendered audio object in the plurality of pre-rendered audio objects; and obtain a bit allocation parameter value of a current audio object to be pre-rendered in the plurality of audio objects to be pre-rendered based on a respective perceptual importance parameter value of the plurality of perceptual importance parameter values of the plurality of pre-rendered audio objects; and
a determining module, configured to determine, based on the bit allocation parameter value of the current audio object to be pre-rendered and a total quantity of to-be-allocated bits corresponding to the plurality of audio objects to be pre-rendered, a target quantity of bits allocated to the current audio object to be pre-rendered.

15. The apparatus according to claim 14, wherein a perceptual importance parameter value of the plurality of perceptual importance parameter values comprises at least one of an energy importance parameter value, a perceptual intensity importance parameter value, or a spectral flatness parameter value, wherein
an energy importance parameter value of the current pre-rendered audio object is obtained through calculation based on energy of the current pre-rendered audio object, and indicates a ratio of the energy of the current pre-rendered audio object to a sum of respective energy of the plurality of pre-rendered audio objects;
a perceptual intensity importance parameter value of the current pre-rendered audio object is obtained through calculation based on an auditory curve of a human ear and energy of the current pre-rendered audio object, and indicates a ratio of a sum of energy of a preset quantity of frequency bands that have maximum energy and that are in a plurality of frequency bands of the current pre-rendered audio object to a sum of energy of a preset quantity of frequency bands that have maximum energy and that are in respective plurality of frequency bands of the plurality of pre-rendered audio objects; and
a spectral flatness parameter value of the current pre-rendered audio object indicates spectral flatness of the current pre-rendered audio object in the plurality of pre-rendered audio objects.

16. The apparatus according to claim 14, wherein the current pre-rendered audio object is an audio object obtained by pre-rendering the current audio object to be pre-rendered, and the bit allocation parameter value of the current audio object to be pre-rendered comprises a first ratio, or a parameter value determined based on the first ratio; and
wherein the first ratio is a ratio of the perceptual importance parameter value of the current pre-rendered audio object to a sum of the plurality of perceptual importance parameter values of the plurality of pre-rendered audio objects.

17. The apparatus according to claim 14, wherein
the obtaining module is further configured to obtain a plurality of content importance parameter values of the plurality of audio objects to be pre-rendered, each audio object of the plurality of audio objects to be pre-rendered having a respective content importance parameter value of the plurality of content importance parameter values, wherein a content importance parameter value of the plurality of content importance parameter values of the current audio object to be pre-rendered indicates an importance degree of a sound type represented by content of the current audio object to be pre-rendered in sound types represented by content of the plurality of audio objects to be pre-rendered; and
wherein the obtaining module is further configured to:
obtain the bit allocation parameter value of the current audio object to be pre-rendered based on a respective perceptual importance parameter value of the plurality of perceptual importance parameter values of the plurality of pre-rendered audio objects and a respective content importance parameter value of the plurality of content importance parameter values of the plurality of audio objects to be pre-rendered.

18. The apparatus according to claim 17, wherein the current pre-rendered audio object is an audio object obtained by pre-rendering the current audio object to be pre-rendered, and the bit allocation parameter value of the current audio object to be pre-rendered comprises a second ratio, or a parameter value determined based on the second ratio; and
wherein the second ratio is a ratio of a first value of the current audio object to be pre-rendered to a sum of a plurality of first values of the plurality of audio objects to be pre-rendered, and the first value of the current audio object to be pre-rendered is a product of the respective content importance parameter value of the current audio object to be pre-rendered and the respective perceptual importance parameter value of the current pre-rendered audio object, or the first value of the current audio object to be pre-rendered is a parameter value determined based on a product of the respective content importance parameter value of the current audio object to be pre-rendered and the respective perceptual importance parameter value of the current pre-rendered audio object.

19. The apparatus according to claim 17, wherein the sound type comprises at least one of: voice, music, sound effect, ambient sound, or noise.

20. The apparatus according to claim 14, wherein a ratio of the target quantity of bits allocated to the current audio object to be pre-rendered to the total quantity of to-be-allocated bits is equal to a third ratio, or is equal to a parameter value determined based on the third ratio; and
wherein the third ratio is a ratio of the bit allocation parameter value of the current audio object to be pre-rendered to a sum of a plurality of bit allocation parameter values of the plurality of audio objects to be pre-rendered.

21. The apparatus according to claim 14, wherein the determining module is further configured to:
determine a priority level of the current audio object to be pre-rendered based on the bit allocation parameter value of the current audio object to be pre-rendered and a correspondence between a plurality of bit allocation parameter values and a plurality of priority levels; and
determine, based on the priority level of the current audio object to be pre-rendered and the total quantity of to-be-allocated bits, the target quantity of bits allocated to the current audio object to be pre-rendered.

22. The apparatus according to claim 21, wherein a ratio of the target quantity of bits allocated to the current audio object to be pre-rendered to the total quantity of to-be-allocated bits is equal to a fourth ratio, or is equal to a parameter value determined based on the fourth ratio; and
wherein the fourth ratio is a ratio of the priority level of the current audio object to be pre-rendered to a sum of a plurality of priority levels of the plurality of audio objects to be pre-rendered.

23. The apparatus according to claim 14, wherein the determining module is further configured to:
obtain an initial quantity of bits allocated to the current audio object to be pre-rendered;
adjust the bit allocation parameter value of the current audio object to be pre-rendered based on the initial quantity of bits; and
determine, based on the total quantity of to-be-allocated bits and an adjusted bit allocation parameter value of the current audio object to be pre-rendered, the target quantity of bits allocated to the current audio object to be pre-rendered.

24. The apparatus according to claim 23, wherein the adjusted bit allocation parameter value of the current audio object to be pre-rendered comprises a fifth ratio or a parameter value determined based on the fifth ratio; and
wherein the fifth ratio is a ratio of a second value of a plurality of second values of the current audio object to be pre-rendered to a sum of the plurality of second values of the plurality of audio objects to be pre-rendered, and the second value of the current audio object to be pre-rendered is a product of the initial quantity of bits and the bit allocation parameter value of the current audio object to be pre-rendered, or the second value of the current audio object to be pre-rendered is a parameter value determined based on a product of the initial quantity of bits and the bit allocation parameter value of the current audio object to be pre-rendered.

25. The apparatus according to claim 24, wherein the ratio of the target quantity of bits allocated to the current audio object to be pre-rendered to the total quantity of to-be-allocated bits is equal to the adjusted bit allocation parameter value of the current audio object to be pre-rendered, or is equal to a parameter value determined based on the adjusted bit allocation parameter value of the current audio object to be pre-rendered.

26. The apparatus according to claim 14, wherein the apparatus further comprises:
a sending module, configured to send a plurality of proportion information of target quantities of bits respectively allocated to the plurality of audio objects to be pre-rendered, wherein the plurality of proportion information is used to reconstruct the plurality of audio objects to be pre-rendered.

27. The apparatus according to claim 14, wherein the apparatus is an encoder, or the apparatus is an encoding device comprising the encoder.

28. The apparatus according to claim 27, wherein the encoder is a stereo encoder or a multi-channel encoder.

29. A bit allocation apparatus for an audio object, comprising a memory and a processor, wherein the memory is configured to store a computer program, and the processor is configured to invoke the computer program, to perform:
separately pre-rendering a plurality of audio objects to be pre-rendered in a to-be-encoded audio frame, to obtain a plurality of pre-rendered audio objects;
obtaining a plurality of perceptual importance parameter values of the plurality of pre-rendered audio objects, each pre-rendered audio object of the plurality of pre-rendered audio objects having a respective perceptual importance parameter value of the plurality of perceptual importance parameter values, wherein a perceptual importance parameter value of the plurality of perceptual importance parameter values of a current pre-rendered audio object in the plurality of pre-rendered audio objects indicates a perceptual importance degree of the current pre-rendered audio object in the plurality of pre-rendered audio objects;
obtaining a bit allocation parameter value of a current audio object to be pre-rendered in the plurality of audio objects to be pre-rendered based on a respective perceptual importance parameter value of the plurality of perceptual importance parameter values of the plurality of pre-rendered audio objects; and
determining, based on the bit allocation parameter value of the current audio object to be pre-rendered and a total quantity of to-be-allocated bits corresponding to the plurality of audio objects to be pre-rendered, a target quantity of bits allocated to the current audio object to be pre-rendered.

30. The bit allocation apparatus for an audio object according to claim 29, wherein a perceptual importance parameter value of the plurality of perceptual importance parameter values comprises at least one of: an energy importance parameter value, a perceptual intensity importance parameter value, or a spectral flatness parameter value, wherein an energy importance parameter value of the current pre-rendered audio object is obtained through calculation based on energy of the current pre-rendered audio object, and indicates a ratio of the energy of the current pre-rendered audio object to a sum of respective energy of the plurality of pre-rendered audio objects;
a perceptual intensity importance parameter value of the current pre-rendered audio object is obtained through calculation based on an auditory curve of a human ear and energy of the current pre-rendered audio object, and indicates a ratio of a sum of energy of a preset quantity of frequency bands that have maximum energy and that are in a plurality of frequency bands of the current pre-rendered audio object to a sum of energy of a preset quantity of frequency bands that have maximum energy and that are in respective plurality of frequency bands of the plurality of pre-rendered audio objects; and
a spectral flatness parameter value of the current pre-rendered audio object indicates spectral flatness of the current pre-rendered audio object in the plurality of pre-rendered audio objects.
